(19) United States
(12) Patent Application Publication
(10) Pub. No.: US 2026/0337825 A1
(43) Pub. Date: Oct. 29, 2026

(54) METHOD AND APPARATUS FOR PRODUCING A VEHICLE INTERIOR COMPONENT

(71) Applicant: LEAR CORPORATION, Southfield, MI (US)

(72) Inventors: Joshua HALLOCK, Warren, MI (US); Eric REPKE, Milford, MI (US); Mark KARGES, Macomb, MI (US); James Gerry WILLIAMS, Highland, MI (US); Samuel BLAIR, Troy, MI (US); David ABDELLA, Royal Oak, MI (US); Michelle A. BRUDZYNSKY, Farmington Hills, MI (US); Lisa SWIKOSKI, West Bloomfield, MI (US); Christopher D. JOHNSON, Novi, MI (US)

(73) Assignee: LEAR CORPORATION, Southfield, MI (US)

(21) Appl. No.: 19/481,841

(22) PCT Filed: May 11, 2024
(86) PCT No.: PCT/US2024/029011

§ 371 Date: Nov. 5, 2025

Related U.S. Application Data
(63) Continuation-in-part of application No. 18/316,353, filed on May 12, 2023, now Pat. No. 12,286,044.
(60) Provisional application No. 63/521,222, filed on Jun. 15, 2023.
(60) Provisional application No. 63/602,849, filed on Nov. 27, 2023.

(30) Foreign Application Priority Data
Mar. 13, 2024 (DK) PA202470079

(51) Int. Cl. D01D 5/088; F01M 11/02

(52) U.S. Cl. CPC D01D 5/0885; F01M 11/02

(57) ABSTRACT

An assembly is provided with a funnel having side walls extending from an entrance to an outlet, and a liner having one or more elastic panels. A system is provided with the assembly, a fluid bath, and a hose to direct fluid from the fluid bath onto the liner. A method includes covering an inner surface of a funnel with a liner comprising one or more elastic panels, wetting the liner, and forming a stranded mesh material member by extruding material through the funnel. A stranded mesh material member is formed using the method. An apparatus and method for preparing a cushion body made of polymeric filaments is disclosed. The apparatus includes a shaping assembly having one or more dynamic portions for shaping the cushion body. The shaping assembly may include a funnel and movable sections with associated actuators cooperating to define and change the shape of an opening.

### CROSS-REFERENCE TO RELATED APPLICATIONS

This application claims priority to and is a continuation-in-part of U.S. patent application Ser. No. 18/316,353 filed on May 12, 2023, the disclosure of which is hereby incorporated in its entirety by reference herein.

This application also claims priority to Denmark Patent Application No. DK PA202470079 filed Mar. 13, 2024, U.S. Provisional Patent Application Nos. 63/602,849 filed Nov. 27, 2023, and 63/521,222 filed Jun. 15, 2023, the disclosures of which are hereby incorporated in their entirety by reference herein.

### TECHNICAL FIELD

Various embodiments relate to a method, system, and assembly for producing a vehicle interior component such as a nonfoam cushion, as well as methods and equipment to produce cushion assemblies and more specifically foamless or non-foam cushion assemblies such as bodies of entangled and/or bonded polymeric strands.

### BRIEF DESCRIPTION OF THE DRAWINGS

FIG. 1 shows a schematic illustration of a system and method in accordance with embodiments described herein;

FIG. 2 shows a consolidated filament structure for an interior component and for use as a cushion blank for a vehicle seat formed in accordance with embodiments described herein;

FIG. 3 is a front perspective view of a seat assembly according to some embodiments and with an interior component formed in accordance with embodiments described herein;

FIG. 4 is a perspective view of an assembly with a funnel and liner according to some embodiments, and for use with the system and method of FIG. 1;

FIG. 5 is a top plan view of a liner according to some embodiments and for use with the system of FIG. 1 or the assembly of FIG. 4 prior to installation on a funnel;

FIG. 6 is a top plan view of a liner according to some embodiments and for use with the system of FIG. 1 or the assembly of FIG. 4 prior to installation on a funnel;

FIG. 7 is a top view of a funnel and liner according to other embodiments and for use with the system of FIG. 1 or the assembly of FIG. 4;

FIG. 8 is a perspective sectional view of the funnel and liner of FIG. 7 according to various embodiments;

FIG. 9 is a front perspective view of a manufacturing assembly;

FIG. 10 is a perspective view of a portion of a manufacturing assembly with a plurality of movable sections in a first position;

FIG. 11 is a top view of a shaping tool with the plurality of movable sections in a second position;

FIG. 12 is a top view of a shaping tool with a some embodiments for actuation;

FIG. 13 is a perspective view of a portion of a some embodiments of an actuation assembly, for example, as shown in FIG. 12;

FIG. 14 is a side view of the actuation assembly as shown in FIGS. 12-13;

FIG. 15 is a zoomed-in side view of the actuation assembly of FIGS. 12-14 focusing on a track system;

FIG. 16 is a cross-sectional view of some embodiments of a shaping tool; and

FIG. 17 is a flow chart of a method of making one or more foamless cushions.

FIG. 18 illustrates a method for forming and shaping a product according to some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As required, detailed embodiments of the present invention are disclosed herein. However, it is to be understood that the disclosed embodiments are merely examples of the invention that may be embodied in various and alternative forms. The figures are not necessarily to scale. Some features may be exaggerated or minimized to show details of particular components. Specific structural and functional details disclosed herein are not to be interpreted as limiting, but merely as a representative basis for teaching one skilled in the art to variously employ the present invention.

As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose implies the mixtures of any two or more of the members of the group or class are equally suitable or preferred. Molecular weights provided for any polymers refers to number average molecular weight. A description of constituents in chemical terms refers to the constituents at the time of addition to any combination specified in the description and does not necessarily preclude chemical interactions among the constituents of a mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” or “generally” may modify a value or relative characteristic disclosed or claimed in the present disclosure. In such instances, “substantially” or “generally” may signify that the value or relative characteristic it modifies is within manufacturing tolerances or within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4. 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

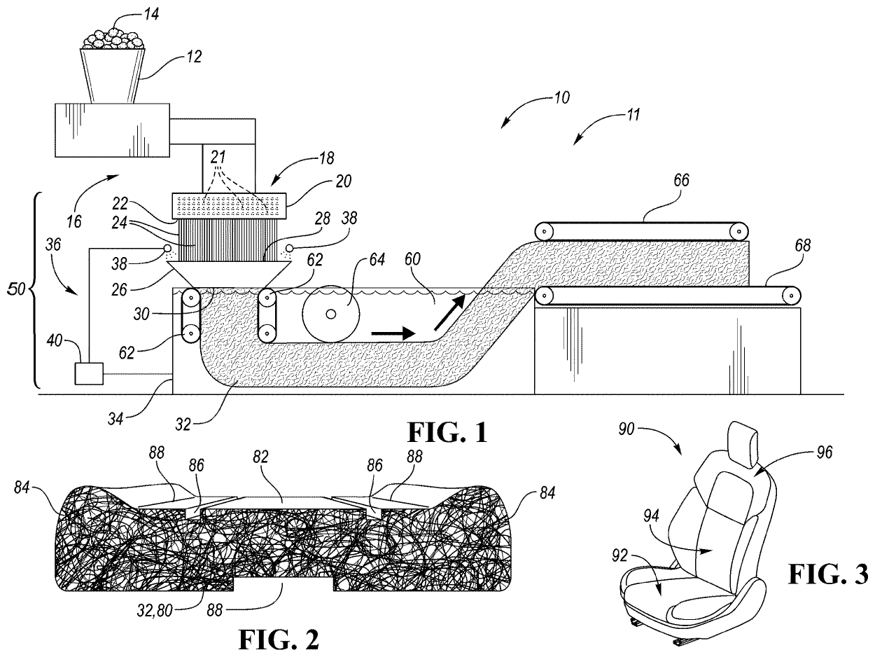

Referring to FIG. 1, a schematic illustration of a system 10 usable with a method 11 in accordance with embodiments described herein is shown. A hopper 12 holds solid granules of a polymeric material 14 that is to be extruded. In some embodiments, the material 14 is linear low-density polyethylene (LLDPE), although methods described herein may use different types of polymers or thermoplastic resins or materials as desirable and effective to produce the finished product. The material 14 is fed from the hopper 12 to an extruder 16. The extruder 16 melts and transports the material 14 to a die 18, which includes a die plate 20. The extruder 16 may be, for example, a conventional extruder that includes a barrel that receives a rotatable screw. Rotation of the screw forces the material 14 to move through the barrel and helps heat the material because of the friction generated as the screw rotates. Heating elements may be disposed on the barrel and heat the polymeric material 14 inside the barrel.

The material 14 exits the extruder 16 at location 22 under pressure and in a molten state, e.g. as a pressurized molten thermoplastic resin. Unless otherwise stated, the term “molten” as used herein means that the material is at least partially melted. It does not mean that the material is necessarily in a fully liquid state; rather, it means that the material is not completely solid and is still able to flow through elements of the system 10. For example, the molten material is still able to flow through the die plate 20, but it may be very viscous and starting to solidify. Once the solid granules of the polymeric material 14 are melted in the extruder 16, the material will begin to cool as it ceases to be agitated by the extruder screw and gets farther from any heaters. At different points in the process 11, the material may have a higher or lower viscosity, but if it is still partially melted and able to flow-even slowly-the term “molten” is applied herein. The polymeric material or resin as disclosed herein may be seen as a thermoplastic material or resin. For example, a filament of (such as a plurality of filaments of) molten polymeric material or resin as disclosed herein may be seen as a filament of (such as a plurality of filaments of) molten thermoplastic material or resin.

The die plate 20 extrudes the material 14 into filaments 24 or strands 24. More specifically, the die plate 20 has multiple apertures 21 or holes 21 disposed therethrough-only some of which are labeled in FIG. 1 for clarity-through which the molten material 14 passes. A single filament 24 or strand is extruded from each aperture 21 of the die 18. The filaments 24 fall downward from the die plate 20 under system pressure and the force of gravity to a funnel 26. The die 18 may be positioned adjacent to an entrance 28 to the funnel 26.

The funnel 26 helps consolidate or group the filaments 24 into a more compact arrangement in which the filaments 24 bend or loop, and each filament 24 contacts and bonds to at least one other filament 24 to form a porous mesh structure. In some embodiments, the funnel 26 has a funnel entrance 28 and a funnel outlet 30 that is smaller than the funnel entrance 28. More specifically, the funnel 26 is narrower at the funnel outlet 30 than at the funnel entrance 28. Individual separated filaments 24 enter the funnel entrance 28, the filaments 24 then bend, loop, buckle, and/or intersect within the profile defined by the funnel 26, move into contact with each other as they accumulate and slide down the funnel 26 toward the funnel outlet 30, and the consolidated filament structure 32 exits the funnel outlet 30 and enters a fluid bath 34, or water tank 34. When the filaments 24 reach the funnel 26, those filaments near the outer part of the funnel 26—approximately 1-3 rows—may slide down an angled surface of the funnel 26, which may create a skin on the consolidated filament structure 32. The consolidated filament structure 32 may also be known as or referred to as a stranded mesh material member 32, as used herein.

The funnel 26 may be partially submerged in the fluid bath 34. For example, the funnel 26 may be positioned with the outlet 30 submerged in the fluid bath 34, and the entrance 28 positioned outside the fluid bath 34 and above the outlet 30.

A wetting system 36 is provided for the funnel 26, and may include at least one hose 38 positioned adjacent to the entrance 28 to the funnel 26 that directs fluid towards the funnel 26 to wet the funnel 26 as described below. The at least one hose 38 may be in fluid communication with the fluid bath 34, and a pump 40 may be provided. The at least one hose 38 may be provided with multiple outlet port, for example, as small apertures through the hose itself so that it weeps onto the funnel 26, or with spray nozzles connected to the hose and directing fluid from the hose towards the funnel 26.

The funnel 26 is described in further detail below, and may be used to provide a desired shape for the consolidated filament structure 32. The funnel 26 may be a part of an assembly 50 for the system 10, with the assembly 50 including the funnel 26 along with the die 18, fluid bath 34, and/or wetting system 36.

The fluid bath 34 holds a fluid 60, such as a liquid fluid or liquid water 60, and receives the consolidated filament structure 32 from the funnel 26. The fluid 60 performs at least two functions. First, it helps to temporarily support the consolidated filament structure 32 to prevent it from collapsing or condensing into a less open or less porous arrangement. As such, the water 60 provides some resistance that causes the additional bending, looping, buckling, and intersecting of the filaments 24 to further build the consolidated filament structure 32. Second, the water 60 cools the polymeric filaments 24 from the outside to solidify them. The temperature of the water 60 may be much less than the temperature of the filaments 24 as they leave the die plate 20, for example, it may be at the temperature of the ambient environment surrounding the tank 34. Although the fluid used in some embodiments is liquid water 60, in other embodiments, other types of fluids may be used.

The fluid bath 34 includes various rollers and conveyors that help move the consolidated filament structure 32 through and out of the water 60. A tractor conveyor 62 is submerged in the water 60 and engages opposing lateral sides of the consolidated filament structure 32 to move it away from the funnel 26 at approximately the same speed as the consolidated filament structure 32 exits the funnel 26. The gap between the opposing portions of the tractor conveyor 62 may be slightly narrower than the width of the consolidated filament structure 32 to allow the tractor conveyor 62 to better grip the consolidated filament structure 32. As previously noted, FIG. 1 is a schematic representation and has been simplified for illustration purposes. For example, a conveyor, such as the tractor conveyor 62, may be located toward the front and back of the system 10 as it is oriented in FIG. 1, rather on the left and right sides as shown.

Another roller 64 helps keep the consolidated filament structure 32 submerged and helps guide it through the water 60 toward a conveyor belt 66 and a shaker table 68 that are positioned outside of the fluid bath 34. The shaker table 68 shakes the consolidated filament structure 32 while it is on the conveyor belt 66 to remove at least some of the water 60. Pressurized air may also be blown toward the consolidated filament structure 32, which may also be squeezed to remove more of the water 60. Finally, the consolidated filament structure 32 may be cut to a desired size and shape.

The consolidated filament structure or stranded mesh material member is intended for use as a vehicle interior component. For example, the consolidated filament structure 32 may be used as a cushion blank or cushion member for part of a vehicle seat as described below with reference to FIG. 2, or as another interior component for a vehicle. The consolidated filament structure 32 may provide a non-woven thermoplastic cushion for a seat assembly. To reduce time and cost-particularly in postprocessing operations-the consolidated filament structure 32 may be formed with systems and methods described herein, e.g. with a funnel according to the present disclosure, to create a net-or near-net-shaped structure.

FIG. 2 shows a consolidated filament structure 32 or stranded mesh material member 32 forming a cushion blank 80, created using embodiments such as described above and for use as a seat cushion in a vehicle seat assembly. The cushion blank 80 may be formed with a base layer 82 bonded to, and/or formed as a skin 82 unitarily with, the plurality of strands. As shown in the Figure, and by way of one non-limiting example, the consolidated filament structure 32 may be formed with a contoured shape or cross-sectional profile with a complex geometry using the funnel 26 as described herein. The consolidated filament structure 32 was extruded and traveled through the funnel along an axis that extends into the page. The consolidated filament structure 32 may be formed with one or more convex regions 84, channels 86 or trenches 86, and/or concave regions 88.

In this way, the use of a funnel as described herein, may be used to create a consolidated filament structure having a desired shape. The consolidated filament structure 32 may be formed with different types of shapes useful for different applications. For example, the consolidated filament structure may be intended for use as a cushion blank for a vehicle interior component, such as a vehicle seat, and may be contoured for occupant support and comfort. For example, the consolidated filament structure may be formed with convex regions 84, e.g. for bolsters, or other concave or convex regions to form a desirable shape for a seated occupant. Additionally or alternatively, the consolidated filament structure may be formed with one or more channels 86 in a surface of the cushion blank, which may form a convenient location to attach a trim cover, or with concave regions 88 either for shaping or to locate a seat component, such as a bladder or other cushion member.

FIG. 3 illustrates a seat assembly 90 as a vehicle seat assembly 90 according to some embodiments. Although the vehicle seat assembly 90 is illustrated and described, any seat assembly 90 may be employed. The seat assembly 90 may be utilized in a land vehicle, aircraft, watercraft, or the like. The seat assembly 90 may also be utilized as an office chair, comfort chair, or the like.

The depicted seat assembly 90 includes a seat bottom cushion 92 to support a pelvis and thighs of a seated occupant. The seat assembly 90 also includes a seat back cushion 94 to support a back and shoulders of the seated occupant. The seat bottom cushion 92 and/or the seat back cushion 94 may each be formed from one or more cushion blanks 80 as described above. In one example, the cushions 92, 94 are formed from stranded mesh material cushion blanks such that they are non-foam cushions. In other examples, one or both of the cushions 92, 94 may be provided with one or more foam components such as a component formed from molded polyurethane foam, or other nonfoam components, in addition to the stranded mesh material nonfoam cushions. A trim cover 96 is provided over the seat cushions 92, 94 to conceal the cushions 92, 94 and provide a uniform and smooth contact surface for the occupant.

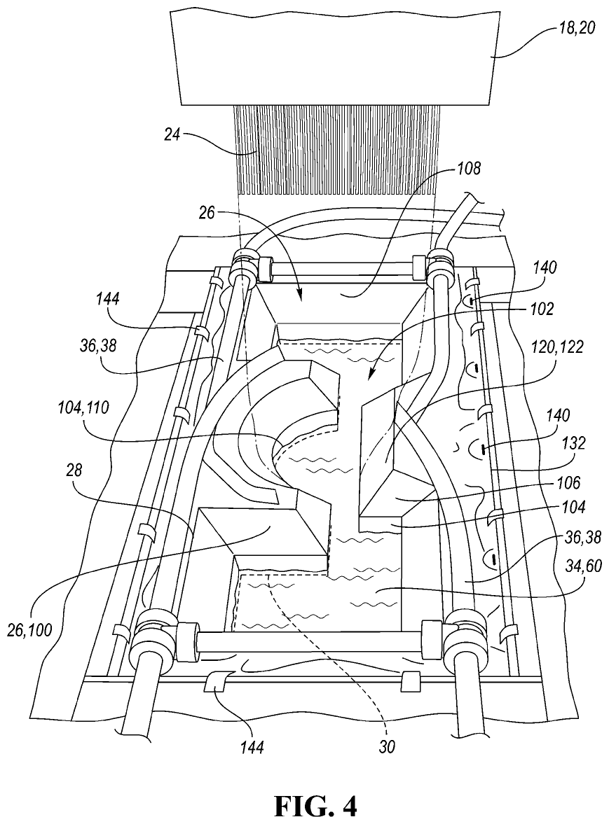

FIG. 4 illustrates an assembly 50 according to some embodiments and for use with the funnel according to some embodiments and for use with the system 10 and method of FIG. 1. Elements that are the same as or similar to those described above with reference to FIG. 1 are given the same reference numbers for simplicity.

The die 18 is illustrated with strands or filaments 24 extending downwardly from the series of apertures in the die plate 20 towards a funnel 26. As shown, the die 18 is positioned adjacent to and above an entrance 28 to the funnel.

The funnel 26 is positioned between the die 18 and the fluid bath 34. As shown, the funnel 26 is positioned with the outlet 30 submerged in the fluid bath 34 or below the fluid 60 level, and the entrance 28 is positioned outside the fluid bath 34 and above the outlet 30.

The funnel 26 has one or more side walls 100 that extend from the entrance 28 to the outlet 30 of the funnel. The outlet 30 has a smaller cross-sectional area than the entrance 28. The side walls 100 of the funnel form or defines an inner wall or inner surface for the funnel surrounding the central area 102. The side walls 100 may extend continuously about the central area 102 or interior region of the funnel. The side walls 100 may further provide a rigid support structure for the funnel from the entrance 28 to the outlet 30, e.g. as continuous, rigid support walls. The side walls 100 may be formed from shaped sheets of metal, plastic, or another material, formed using machining into a block of material such as metal or plastic, e.g. via milling, or may be formed using additive manufacturing or three-dimensional printing techniques.

The entrance 28 has an associated cross-sectional shape or profile, and the outlet has 30 an associated cross-sectional shape or profile. In various examples, and as shown, the shape of the entrance 28 generally corresponds to the shape of the outlet 30, e.g. with the entrance and outlet shapes differing in overall size, or scaled, relative to one another. In further examples, the shapes of the entrance 28 and outlet 30 may be varied or altered relative to one another, e.g. to cause a section of skin on the filament structure 32 to be directed in a specific manner, or when the funnel 26 contains complex shapes where a constant offset or scaling between the entrance 28 and outlet 30 for those features is unfeasible. The cross-sectional shapes of the entrance 28 and outlet 30, and the general cross-sectional shape of the funnel 26 may be formed to provide and shape the overall cross-sectional shape of the consolidated filament structure 32 or extruded member.

The cross-sectional shape of the funnel 26 defined by the side walls 100 may be a non-rectangular shape, and may further include concave shapes or surfaces 104 and/or convex shapes or surfaces 106, with planar sections 108 and/or curved sections 110, extending from the entrance 28 to the outlet 30. In one example, and as shown, the one or more side walls 100 of the funnel define at least one concave surface 104 and at least one convex surface 106.

With reference to FIGS. 4-6, a liner 120 is provided, and extends over or covering an inner surface of the one or more side walls 100 to line the interior region of the funnel 26. The liner 120 is stretched over the side walls 100 of the funnel 26, and is supported by the funnel. The liner 120 is stretched over the funnel 26 such that the liner 120 follows and conforms to the complex shape of the inner surface of the funnel 26, while avoiding wrinkles in the liner. The liner 120 may be formed from one or more panels as described below. For a liner 120 with multiple panels, the panels may be sewn, glued, or otherwise connected to one another.

The liner 120 comprises at least one elastic panel 122. The elastic panel 122 may be formed from a material with two-way or four-way stretch, and in one non-limiting example, is provided by a material with fifteen percent stretch in a direction. In one example, each elastic panel 122 is formed from or comprises a knit fabric. In other examples, each elastic panel 122 is formed from or comprises at least one of a polyester elastic material, elastane, nylon, natural fiber, and/or rubber core yarn. In further example, each elastic panel 122 may be formed from or comprise any other type of two-way or four-way stretch fabric.

For a liner 120 with more than one elastic panel 122, the elastic panels 122 may be formed from the same material, e.g. to account for complex funnel geometry 26, or may be formed from different elastic materials, or elastic materials with different properties from one another, e.g. to provide differing amount of stretch for different shaped regions of the funnel and/or account for complex funnel geometry.

In one example, the liner 120 is formed from only elastic panel(s) 122. In other examples, the liner 120 may include both elastic panel(s) 122 as well as non-elastic panel(s) 124. According to various examples, the non-elastic panel(s) 124 may be formed from a woven or non-woven fabric, including DUON, duck cloth or canvas, or another material with similar properties.

In one example, the liner 120 includes at least one nonelastic panel 124 adjacent to an inner edge 130 or an outer edge 132 to connect to associated fasteners as described below. In other examples, the liner 120 is formed from only elastic panel(s) 122, or the fasteners are connected directly to the elastic panel(s) 122.

In one example, the liner 120 has an inner edge 130 defining an aperture 134 therethrough, with the liner 120 extending outwardly from the inner edge 130 to an outer peripheral edge 132 of the liner. In one example, the inner edge 130 may generally correspond to the shape of the outlet 30 of the funnel, and/or the outer edge 132 may generally correspond to the entrance 28 of the funnel. In other examples, the shapes of the inner and outer edges 130, 132 differ from the cross-sectional shape of the funnel 26, for example, based on the location or type of fasteners used, to control stretch of the liner 120 in different regions of the funnel, or the like.

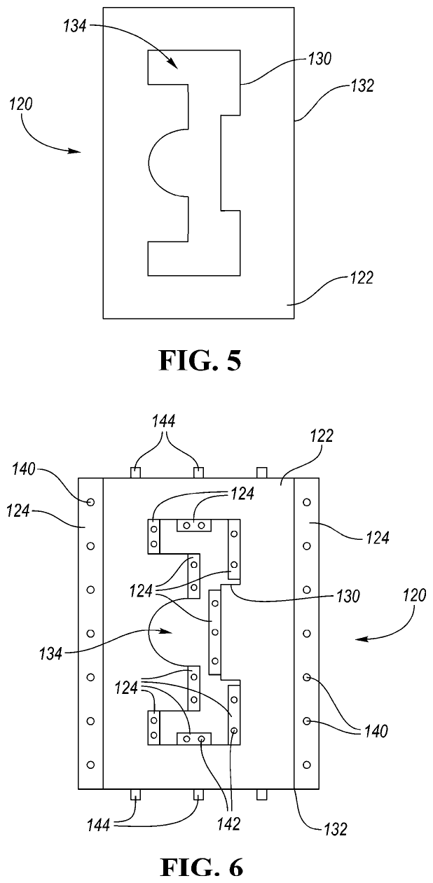

The liner 120 may be formed from a single panel or single sheet of material, with the inner and outer edges 130, 132 cut from the single panel, as described below with reference to FIG. 5. In other examples, the liner 120 may be formed from multiple panels that are connected to one another such that the liner may be used with a more complexly shaped funnel, and extend from an inner edge 130 to the outer edge 132.

One or more first fasteners 140 may be provided, and are connected adjacent to the outer edge 132 of the liner 120. The first fastener 140 may include at least one of a staple, clip, snap, grommet, hook, sewn-in wire or bead, hook or loop, tape, J-retainer, or the like.

One or more second fasteners 142 may also be provided, and are connected adjacent to the inner edge 130 of the liner 120. The second fastener 142 may include at least one of a staple, clip, snap, grommet, hook, sewn-in wire or bead, hook or loop, tape, J-retainer, or the like.

As described above, each first and/or second fastener 140, 142 may be directly connected to an elastic panel 122 of the liner 120, or may be attached is a non-elastic panel 124 at an inner edge 130 or outer edge 132 of the liner that is used to support the associated fastener. Furthermore, the liner 120 may use different types of fasteners in different regions of the funnel 26. Additionally, a mixture of fasteners as first fasteners 140 and/or second fasteners 142 may be used, e.g. with corresponding hook and loop fasteners positioned between hook and grommet fasteners to maintain stretch and positioning of the liner between adjacent hooks and grommets.

In one example, and as described further below with reference to FIG. 8, the liner 120 is connected to itself, e.g. by wrapping the liner 120 around the funnel 26, and with the inner edge 130 connected to the outer edge 132 away from the interior region 102 of the funnel. The first and second fasteners 140, 142 may therefore complement one another such that they are connected to one another to secure the liner 120 relative to the funnel 26, e.g. with a hook cooperating with a grommet, a sewn-in wire or bead cooperating with a hook, hook and loop fasteners, corresponding J-retainers, or the like. Alternatively, only a single fastener 140, 142 may be used, e.g. with a staple connecting the inner and outer edges 130, 132 of the liner 120 to one another.

In another example, and as shown in FIG. 4 and alternatively below with reference to FIG. 8, the liner 120 is connected to the funnel 26 itself, with the inner edge 130 of the liner 120 connected to the funnel 26 and the outer edge 132 of the liner 120 connected to the funnel 26 away from the interior region 102 of the funnel 26. In one example, each first fastener 140 connects to the funnel 26 adjacent to and outboard of the entrance 28, and each second fastener 142 connects to the funnel 26 adjacent to and outboard of the outlet 30. The first fastener(s) 140 of the liner 120 may connect to a corresponding fastener 150 provided on the funnel 26, and the second fastener(s) 142 of the liner 120 may likewise connect to another corresponding fastener 150 on the funnel. The fasteners 150 on the funnel 26 may be provided as described above with respect to fasteners 140, 142, and connected to or otherwise supported by the funnel 26. In one example, there are separate sets of fasteners 150 connected to the funnel 26 to cooperate with the first and second fasteners 140, 142. In another example, the first and second fasteners 140, 142 may directly connect to the funnel 26 itself, e.g. via a staple or rivet or the like through the liner 120 and into the funnel 26 material. In the example shown, tags 144 are connected, e.g. sewn, to the elastic panel(s) 122 of the liner 120 on the left hand side of FIG. 4. In one example, fasteners 140 may be connected to the tags 144 to connect the liner 120 to the funnel 26. The tags 144 may be formed from a nonelastic material as described above, and may further be used to pull and stretch the liner 120 when connecting the liner 120 to the funnel 26. In the example shown, staples are used as fasteners 140 to directly connect the liner 120 to the funnel 26 on the right hand side of FIG. 4.

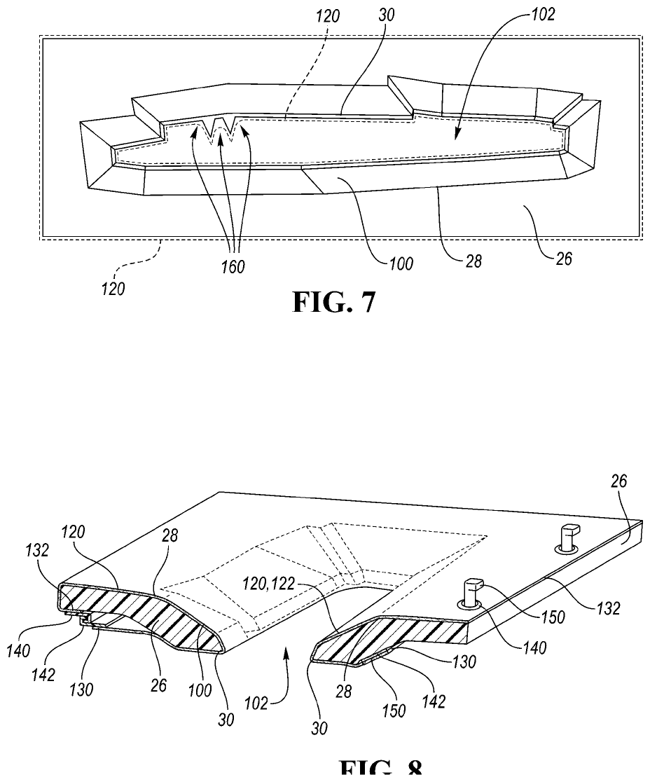

With reference to FIGS. 4 and 7, and for a funnel 26 with a cross-sectional shape having a concave corner 104 or stepped feature, the elastic panel(s) 122 of the liner 120 may provide a softened edge or curve when attached to the funnel 26, e.g. by providing a fillet 160 as the elastic material may stretch across the corner 104 itself, thereby providing an associated filleted shape for the consolidated filament structure 32 that is extruded therethrough. The radius of the fillet 160 may be controlled based on how tightly the elastic panel(s) 122 are stretched over the funnel 26 and over the associated corner 104, with a more tightly stretched liner 120 providing a smaller radius fillet or sharper feature.

The fluid system 36 is shown with the at least one hose 38 positioned adjacent to the entrance 28 to the funnel 26 to wet the liner 120 and funnel 26, e.g. by spraying or otherwise directing fluid from the hose 38 to the liner 120 of the funnel 26. In the example shown, the hose 38 is positioned above the liner 120 and funnel 26. In other examples, the hose 38 may be positioned between the liner 120 and the funnel 26, or in a combination of above and beneath the liner 120. The at least one hose 38 is in fluid communication with the fluid bath 34 such that fluid from the bath is directed to the funnel 26 and liner 120 and then returns to the bath 34 and circulates. The liner 120 and associated panels absorb and wick fluid or water even while stretched or under strain such that they remain wetted as the extruded strands 24 or filaments pass over them.

FIG. 5 illustrates a liner 120 formed from a single panel 122 of an elastic material. In FIG. 5, the liner 120 extends from an inner edge 130 surrounding an aperture 134 to an outer peripheral edge 132. The shapes of the inner and outer edges 130, 132 may generally correspond to one another and to the cross-sectional shape of the funnel 26, or may be different from one another. In the example shown, the outer edge 132 is generally rectangular, while the inner edge 130 corresponds to the cross-sectional shape of the funnel 26. The liner 120 may be cut from a single panel 122, with the aperture 134 and inner edge 130 cut from a central region of the panel 122. The liner 120 is then stretched over the funnel 26 to generally conform to the funnel 26 and provide the three-dimensional shape.

FIG. 6 illustrates a liner 120 formed from multiple panels, including an elastic panels 122, and multiple non-elastic panels 124. The liner 120 extends from an inner edge 130 surrounding an aperture 134 to an outer peripheral edge 132. The shapes of the inner and outer edges 130, 132 may generally correspond to one another and to the cross-sectional shape of the funnel 26, or may be different from one another as shown. The nonelastic panels 124 in the example shown are connected to the elastic panel(s) 122 and may provide support for first and second fasteners 140, 142, such as grommets or another fastener as disclosed herein. The liner 120 may additionally be provided with tags 144 for fasteners or for use in stretching the liner. In edge regions without a fastener 140, 142 shown, the liner 120 may be directly connected to the funnel 26 or the liner 120 itself when assembled.

In another example, the liner 120 may additionally be provided with one or more non-elastic panels 124 to partially cover the inner surface of the funnel 26 itself, e.g. in a planar region 108 that does not require the liner 120 to stretch to conform to the funnel 26. In other examples, the liner 120 may be formed from one or more panels 122 of elastic material, and additionally, may include one or more nonelastic panels 124, either to partially cover the inner surface of the walls 100 of the funnel 26 in cooperation with the elastic panel(s) 122 and/or to provide support for the first and second fasteners 140, 142.

FIGS. 7-8 illustrates a funnel 26 and liner 120 according to other embodiments, and for use with the assembly 50 of FIG. 2 or the system 10 and method of FIG. 1. Elements that are the same as or similar to those described above with reference to FIGS. 1-6 are given the same reference number for simplicity, and reference may be had to the description above. As shown, the funnel 26 has a complex cross-sectional shape with both concave regions 104 and convex regions 106. The side walls 100 extend from the entrance 28 to the outlet 30 of the funnel 26 to surround an interior region 102 of the funnel 26.

In FIG. 7, a top view of a funnel 26 is illustrated according to some embodiments, and showing a different cross-sectional shape for the funnel 26 and resulting extruded consolidated filament structure. The liner 120 is also shown in broken lines. As shown in FIG. 7, the liner 120 may provide a filleted shape 160 in conjunction with the funnel 26, depending on how much the liner is stretched over the funnel.

In FIG. 8, and by way of a non-limiting example, the liner 120 is shown as being connected to itself and wrapped around the funnel 26 on the left hand side of the Figure, and the liner 120 is connected to the funnel 26 on the right hand side of the Figure. The funnel 26 underlying the liner 120 is shown in broken lines. The inner edge 130 is pulled through and away from the outlet 30 of the funnel, and the outer edge 132 is stretched outwardly from the entrance 28. As shown in the Figure, the first and second fasteners 140, 142 on the left hand side of FIG. 8 are provided by corresponding J-retainers that are connected to one another. As shown in FIG. 8, and by way of example, first fasteners 140 on the right hand side of the Figure is a grommet and is connected to a corresponding hook 150 on the funnel, and the second fastener 142 on the right hand side of the Figure is hook or loop fastener and is connected to the other of a hook or loop fastener as fastener 150 on the funnel.

A method is provided. The method may be used with the system 10 of FIG. 1, or the assembly 50 of FIG. 4 according to various non-limiting examples.

An inner surface of the wall(s) 100 of a funnel 26 is covered with a liner 120 comprising one or more elastic panels 122. The liner 120 may be stretched when covering the funnel 26, e.g. by stretching the liner 120 over the inner surface of wall(s) 100 of the funnel to remove any wrinkles in the liner and provide a smooth liner surface. In a further example, the liner 120 may be steamed after it is stretched over the funnel to further remove wrinkles. The liner 120 is fastened to at least one of the funnel 26 and/or the liner 120 to connect or attach the liner 120 to the funnel 26, e.g. using fasteners 140, 142, 150 as described above.

The liner 120 is wetted, e.g. using a fluid system 36. A stranded mesh material member 32 is formed by extruding material as strands or filaments 24 from a die 18 and through the funnel 26, and into a fluid bath 34. The consolidated filament structure 32, also referred to as a stranded mesh material member 32, may then be cut to form a cushion 80 or a cushion blank or a vehicle interior component. In various examples, the cushion is attached to a seat assembly such as a vehicle seat assembly 90.

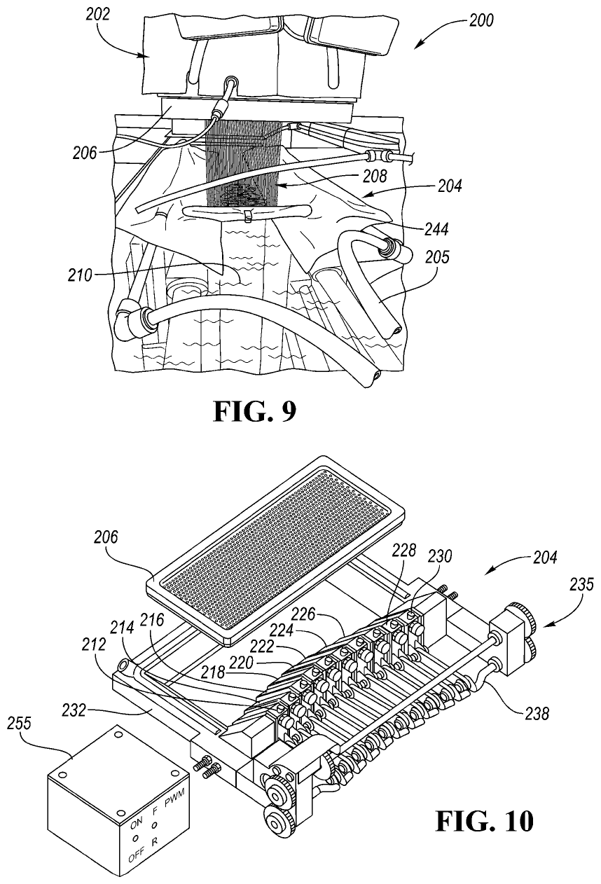

Referring to FIG. 9, an apparatus such as a manufacturing system 200 is disclosed. In various embodiments, the manufacturing system 200 includes a dispenser 202 for dispensing a polymeric material such as an organic polymer resin (e.g., polyolefin, polyethylene, polyurethane) that is received by a shaping assembly or tool 204. The polymeric material may be seen as a thermoplastic material. In other words, the dispenser 202 may be for dispensing a plurality of filaments of molten polymeric material or resin, such as for dispensing a plurality of filaments of molten thermoplastic material or resin. In a variation, the system 200 includes a lubrication system 205 to lubricate one or more components of the system 200 such that the polymeric material can be received and pass through the shaping assembly or tool 204. In a refinement, the dispenser 202 includes a nozzle 206. In a variation, the nozzle 206 includes a plurality of orifices for dispensing a plurality a polymeric filaments 208 (e.g., a foamless cushion body). In a variation, the dispenser 202 is an extruder. In one or more embodiments, the shaping assembly or tool 204 shapes the polymeric material into a desired or predetermined shape before it enters a bath 210 such as a cooling water bath 210. The plurality of polymeric filaments 208 become bound such as by being entangled, intertwined, and/or bonded together to form a body such as a cushion body.

Referring to FIG. 10, the shaping assembly or tool 204 is a dynamic or movable funnel. In various embodiments, the shaping assembly or tool 204 has a peripheral wall 232 with one or more sides defining an opening 206. In some embodiments, the peripheral wall 232 is sloped. For example, the peripheral wall 232 is sloped from an upper outer edge to a lower inner edge such that when it receives a polymeric material from the dispenser 202, the polymeric material translates along the sloped peripheral wall 232 towards the opening 206.

In one or more embodiments, the shaping assembly or tool 204 includes a plurality of movable sections 212-230. In a refinement, the shaping assembly or tool 204 includes at least five movable sections (e.g., 5 to 45 movable sections), or more preferably at least 8 movable sections, or even more preferably at least 10 movable sections. For example, the assembly or tool 204 includes 5 to 100 movable sections, or more preferably 8 to 50 movable sections, or even more preferably 10 to 25 movable sections. In some embodiments, the movable sections 212-230 are disposed in a single side. In other words, each movable side does not correspond to a single side but rather are arranged to alter the shape of a side. For example, a rectangular shaping assembly or tool 204 with four sides is used it has at least five movable sections or at least one side with tow movable sections. In a variation, at least two sides of the shaping assembly or tool 204 include movable sections, or more preferably at least three sides include movable sections, or even more preferably at least four sides include movable sections, or still even more preferably all sides, each include a plurality of movable sections.

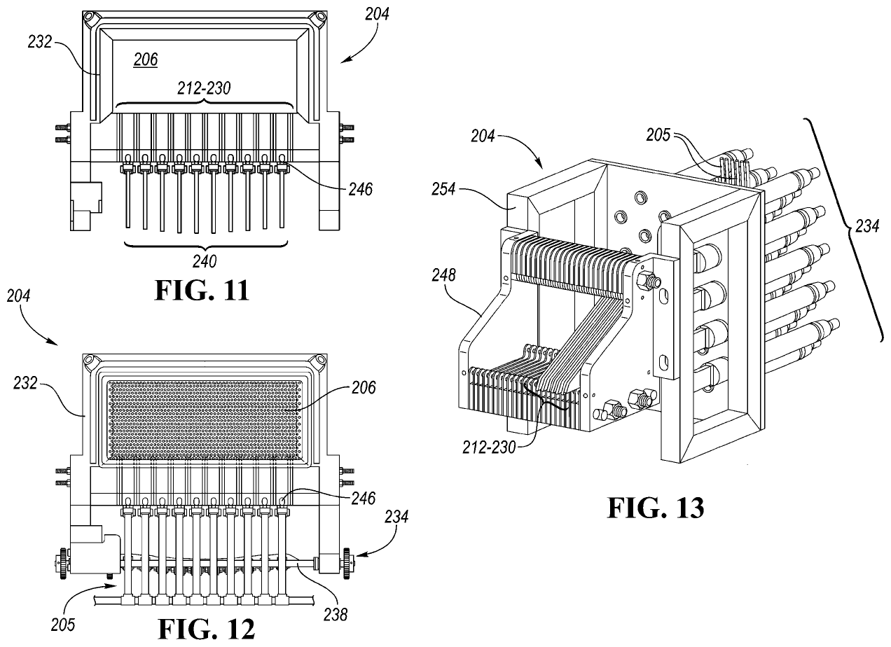

In various embodiments, the movable sections 212-230 cooperate with each other to define the opening 206 such as by forming at least a portion of the peripheral wall 232. The movable sections 212-230 are each at least movable from a first position (as shown in FIG. 10) to a second position (as shown in FIG. 11). In some embodiments, the movable sections are more flexible and dynamic in that they do not have fixed positions (i.e., are not binary). For example, each movable section can be independently positioned such as along a guide such that numerous shapes can be formed by positioning each movable section along the guide at a desired position. The movable sections 212-230 also cooperate with one or more actuators 234 such that when the one or more actuators 234 is actuated at least a portion of the movable sections 212-230 moves from a first position (e.g., FIG. 10) to a second position (e.g., FIG. 11). For example, the one or more movable sections 212-230 are individually and/or independently actuated such as by respective linear servo motors 236 (see FIG. 13). Alternatively, the movable section 212-230 may be actuated together such as through a non-linear shaft 238 (e.g., camshaft/crankshaft), as shown in FIGS. 10 and 12, such that when the shaft is rotated the movable sections move from a first position to a second position. And, in a variation, from a second position to a third position. In a refinement, the first position and/or second position of a first movable section is different than a the first and/or second position of a second movable section. The actuators, in various embodiments, are servos, servo motors, motors, linear actuators, hydraulics, pneumatics, electromechanical, mechanical, or any other suitable actuator.

The non-linear shaft 238 may be particularly suitable if a small number of predetermined shapes are desired for final products. The non-linear shaft 238 is particularly suitable for switching between a straight, convex, and/or concave surfaces/edges/contours. For example, the first position of the movable sections may form a straight, concave, or convex surface or edge and the second position may form a different shape such as a concave or convex surface or edge, i.e., if the first position is straight then the second position is concave or convex, if the first position is concave then the second position is straight or convex, and if the first position is convex then the second position is straight or concave. Still further, the first and second positions may both form a concave or convex shape that is different such as having different degree of curvature. However, when a plurality of actuators is used the funnel is more dynamic and can accommodate a greater number of shapes. For example, each actuator of the plurality of actuators may correspond to a respective movable section (or a group of movable sections).

In some embodiments, one or more gears or transmission 235 (e.g., gear box) is disposed between the one or more actuators 234 and the movable sections 212-230. For example, the one or more gears/transmission 235 rotates to move the one or more of the movable sections 212-230 such as by rotating the non-linear shaft 238. Alternatively, the one or more gears 235 translates along a guide, as shown in FIG. 16, to move the movable sections.

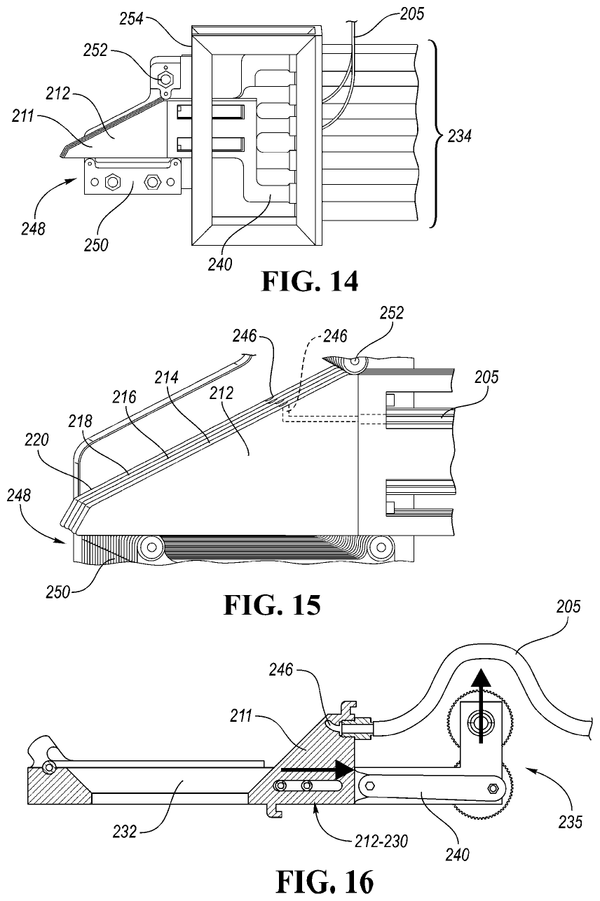

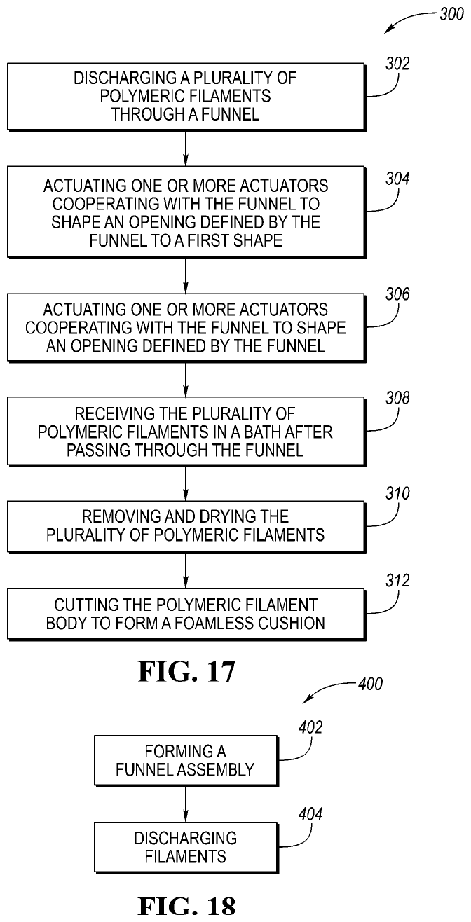

In some embodiments, the movable sections 212-230 translate along a guide 248, as shown in FIGS. 13-15. For example, the guide 248 includes a track system such that each movable section is disposed or rest in a track and the track guides or directs movement of the movable sections. In a refinement, the track system includes a lower track 250 and an upper track 252 for guiding the movable sections during translation. In a variation, the track permits bi-lateral movement. Thus, when the actuator 234, corresponding to the movable section 212, actuates, it moves the movable section 212 along the guide 248 and translates the movable section 212 within the track. In a variation, the guide or track system includes one or more bearing such as V-bearings to facilitate movement/translation. Alternatively, or additional a linear slide may be used to facilitated movement/translation.

In various embodiments, the movable sections 212-230 cooperate with the lubrication system 205 that provides a lubricant such as water to facilitate translation of the polymeric material along the sloped wall and through the opening 206. In a refinement, the lubrication system 205 includes a plurality passages 52 such as tubing (e.g., water lines). For example, each passage 242 cooperates with a movable section (e.g., 212-230) such that the sloped surface is lubricated individually and/or independently by a respective passage 242. In other words, the water lines provide each movable section with lubricant from the lubrication system 205. In various embodiments, the passages 242 are made from a flexible or elastic material that permits a degree of deformation without damage such as plastic tubing such that they tolerate the movement of the movable sections without frequently breaking or detaching. In a refinement, each movable section has a spigot 246 disposed therein for dispensing the lubricant to the movable section. In a variation, the lubricant or water lines cooperate with the movable sections having built-in or integral spigots 246 via fitting or fastener. In one or more embodiments, the shaping assembly or tool 204 (i.e., dynamic funnel) includes a liner 244. In some embodiments, the liner 244 is flexible and/or elastic and provides a surface with smooth transitions rather than jagged or severe transition that may be created by adjacent movable section that are not perfectly aligned (i.e., a movable surface). In a variation, the liner 244 cooperates with the lubricant such as by absorbing the lubricant to facilitate translation of the polymeric material into the opening 206. For example, the liner is an organic polymeric material and/or cloth such as polyethylene (e.g., linear low-density polyethylene). In a refinement, the liner is attached to the movable sections or surface by one or more fasteners such as staples, clips, grommets to hooks, wire, hook and loop tape (e.g., Velcro®), adhesive tape, and/or a combination thereof. Additional details regarding a liner can be found in application Ser. No. 18/316,353 filed on May 12, 2023, which is hereby incorporated by reference in its entirety. In some embodiments, the spigot 246 is positioned to provide the lubricant from beneath the liner 244.

In one or more embodiments, the movable sections 212-230 each include a shaping portion 211 and a connector 240. In some embodiments, the shaping portion 211 and the connector 240 are integral or a single component. In other embodiments, the shaping portion 211 and the connector 240 are joined together such as by a fastener (e.g., pin, bolt, hook, or a combination thereof). In some embodiments, the shaping portion 211 is generally triangular or any other suitable shape. In some embodiments, the movable sections 212-230 cooperate with the one or more actuators 234 by corresponding connectors 240 therebetween. For example, a connector 240 may be attached to each movable section and an actuator. In a variation, each connector 240 is connected to the non-linear shaft 238. In various embodiments, each connector 240 is an elongated rod or thin planar component with a first end connected to a respective movable section 212-230 and a second end connected to the actuator 234 and/or non-linear shaft 238. In other words, the connector 240 extends from the shaping portion 211 to a shaft 238 and/or one or more actuators 234. The connector 240 permits the shaping portions 211 to be spaced away from the one or more actuators 234.

In various embodiments, a frame 254 is included for mounting and supporting the various components of the shaping assembly or tool 204, as shown in FIGS. 13-204. In some embodiments, the frame 254 supports the guide 248, the movable sections 212-230, and/or the one or more actuators 234.

In one or more embodiments, a controller 255 is used to control operation of the shaping assembly or tool 204. The controller 255 is in electrical communication with the one or more actuators 234 and/or the lubrication system 205. For example, the controller 255 provides signals to each actuator to position the corresponding movable section in a desired position along the guide. In some embodiments, the controller 255 is programmed with predetermined positions corresponding to a desired shape. For example, the controller 255 positions the movable sections at a first position to provide a concave shape and moves the movable sections to a second position to provide a convex shape. In various embodiments, the controller 255 also provides signals to the lubrication system 205 such as to meter the lubricant during operation. For example, the controller 255 coordinates with the line speed such that a greater amount of lubricant is provided for faster line speeds and a lesser amount of lubricant is provided for slower line speeds. In some embodiments, the controller 255 is programmed to move the movable sections during operation such that complex shapes are formed in real-time. For example, a cushion for a seat bottom has a surface formed with concave bolsters at opposite ends and a convex seating area between the concave bolster portions. In this way, the controller 255 changes shape during operation in accordance with the line speed to provide the desired shape. For example, the controller 255 moves the movable sections from a first position (e.g., corresponding to the first bolster portion) to a second position (e.g., corresponding to the seating area) and back to the first position (e.g., corresponding to the second bolster portion). In other words, the speed at which actuation from a first predetermined shape to a second predetermined shape based on a line speed. In other words, the controller is programmed to actuate the one or more actuators to a first predetermined position corresponding to a first predetermined shape and from the first position to a second predetermined position corresponding to a second different predetermined shape.

In one or more embodiments, a solid thermoplastic resin is provided such as through a hopper to the dispenser 202 which includes an extruder for shearing and heating the solid thermoplastic resin. Upon shearing and heating the solid thermoplastic resin forms a flowable molten polymeric material. The flowable polymeric material is dispensed or extruded through the nozzle or plurality of nozzles 206 to form a plurality of polymeric filaments 208 that are received by the shaping assembly or tool 204. The shaping assembly or tool 204 shapes and concentrates the polymeric filaments 208 into a cushion body that is then received in a liquid bath 210. For example, in one or more embodiments, the dynamic funnel provides for a greater concentration of polymeric filaments at the edges or surfaces such that a skin-like effect is provided. In various embodiments, the bath 210 is a water and/or cooling bath 210. Cooling to solidify the polymeric filaments and forms a foamless body of bonded, entangled, and intertwined polymeric filaments. In various embodiments, the cooling bath 210 includes a conveyor assembly therein for removing the polymeric body from the bath 210. After removing the body, it is dried.

In one or more embodiments, a method 300 of producing foamless cushion bodies such as for vehicle seat assemblies is provided. The method 300 includes discharging (i.e., step 302) a plurality of polymeric filaments through a funnel and actuating (i.e., step 304) one or more actuators cooperating with the funnel to shape the funnel, an opening defined by the funnel, and the polymeric filaments. As described above, in various embodiments, a polymeric material is heated and sheared to provide a flowable molten polymeric material that is dispensed through a plurality of orifices/nozzles as molten polymeric filaments. The funnel includes one or more movable surfaces that cooperate with corresponding actuators that when actuated change the position of the corresponding movable surface such that the funnel and opening defined therein change shape. Actuation may even occur during operation for more complex shapes. In one or more embodiments, the one or more actuators are actuated such that the movable surfaces are positioned in a first predetermined position, which provides the conglomerate of polymeric filaments forming a cushion body in a first shape as it exits the funnel. In various embodiments, the actuators are actuated to a second position (i.e., step 306) such that the conglomerate of polymeric filaments forming the cushion body is shaped to a second shape as it exits the funnel. In other words, the funnel is dynamic in that its profile can be changed during operation by independent actuation of movable sections or surfaces. In various embodiments, the body or line of bonded, entangled, and intertwined polymeric filament is received in a bath (i.e., step 308) such as a water and/or cooling bath to solidify the flowable molten filament. The foamless body of polymeric filaments is removed from the bath and dried (i.e., step 310) such as by using a conveyor assembly and heat source. If continuous extrusion or dispensing is used for more efficient manufacturing a long line of the foamless body is produced and must be cut or severed (i.e., step 312) to produced foamless cushion bodies. Alternatively, the flowable or polymeric filament may be intermittently dispensed to produce separate foamless bodies.

In one or more embodiments, the controller 255 includes a processor including one or more devices selected from high-performance computing systems including high-performance cores, microprocessors, micro-controllers, digital signal processors, microcomputers, central processing units, field programmable gate arrays, programmable logic devices, state machines, logic circuits, analog circuits, digital circuits, or any other device that manipulate signals (analog or digital) based on computer-executable instructions residing in memory such as in the controller 255. In variations, the memory includes a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. In a refinement, the non-volatile memory/storage includes one or more persistent data storage devices such as a hard drive, optical drive, tape drive, non-volatile solid state device, cloud storage or any other device capable of persistently storing information.

In some embodiments, the executable code/instructions may reside in a software module. In a refinement, the software module includes operating systems and applications. In various embodiments, the software module is compiled or interpreted from a computer program created using a variety of programming languages and/or technologies, including, without limitation, and either alone or in combination, Java, C, C++, C #, Objective C, Fortran, Pascal, Java Script, Python, Perl, and PL/SQL. Non-volatile storage may also include data supporting the functions, features, calculations, and processes.

In some embodiments, the systems described above include computer readable storage media, which is inherently non-transitory, and in various refinements includes volatile or non-volatile, and removable and non-removeable tangible media implemented in any method or technology for storage of information, such as computer-readable instructions, data structures, program modules, or other data. In a variation, computer readable storage media further includes RAM, ROM, erasable programable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. In various embodiments, the computer readable program instructions may be downloaded to a computer, another type of programmable data processing apparatus, or another device form of a computer readable storage medium or to an external computer or external storage device via a network.

In one or more embodiments, the computer readable program instructions stored in a computer readable medium may be used to direct a computer, other types of programmable data processing apparatus, or other devices to function in a particular manner, such that the instructions stored in the computer readable medium produce an article of manufacture including instructions that implement functions, acts, and/or operations described herein. The functions, acts, and/or operations described herein may be re-ordered, processed serially, and/or processed concurrently.

Seat assemblies, seats, or chairs may be used herein to refer generally to an assembly which incorporates the teachings of one or more embodiments disclosed herein, which may include any combination of embodiments, or features of embodiments disclosed herein. Similarly, the terms: seat assembly, seat, or chair may refer to the same or similar assemblies. Seat bottoms, backs, bases, head restraints, headrests, or bolsters may be used herein to refer generally to any component, region or portion of a vehicle interior component, a seat assembly, vehicle seat, or chair. Filaments or strands may be used herein to refer to the generally linear polymeric units (although they may be looped, fused, entangled, intertwined, and/or bonded together to form a mesh-like structure, a contoured unitary mesh product or member, and/or a contoured filament structure) after being dispensed through one or more orifices of the die plate or extrusion die or nozzle of the dispenser, which are likewise used to refer to equivalent components. To bond a plurality of filaments or strands by looping and bonding the plurality of filaments or strands together may be seen as bonding the plurality of filaments or strands by looping and bonding at least two filaments or strands of the plurality of filaments or strands together. For example, filaments or strands that are looped, fused, entangled, intertwined, or bonded together to form a mesh-like structure, a contoured unitary mesh product or member, and/or a contoured filament structure, may comprise at least two filaments or strands being looped, fused, entangled, intertwined, and/or bonded together. In other words, cooling a plurality of strands to bond as a contoured unitary mesh product or member may comprise cooling a plurality of filaments to bond as a contoured filament structure with at least two filaments of the plurality of filaments looped and bonded together. Similarly, the terms: product, a contoured unitary mesh product, contoured filament structure, contoured mesh member, consolidated filament structure, filament structure, stranded mesh material member, filaments of molten thermoplastic material, filaments of molten polymeric material, mesh, mesh member, extruded material, cushion blank, thermoplastic cushion, mesh cushion, foamless cushion, seat cushion, or cushion may refer to the same or similar components. The term funnel, shaping assembly and tool may be used to refer to the same or similar components as well. The term side wall and peripheral wall may be used to the same or similar components for the funnel, and similarly for the term opening with respect to entrance or outlet of the funnel. In yet another example, tank, water tank, fluid bath, liquid bath, lubrication system, and fluid chamber may refer to the same or similar components. In another example, outlet port, spray nozzle, and spigot may refer to the same or similar components. In a further example, the term tractor conveyor and conveyor assembly may refer to the same or similar components. The use of different terms to refer to the same or similar components may be used to avoid confusion when describing different preferred embodiments. The terms may be interchangeable as various components of features from various embodiments may be combined in manners not expressly described herein. This does not detract from the fact that certain terms may provide inherent detail not included by other interchangeable term(s) unless expressly stated otherwise (e.g., water tank and fluid chamber refer to similar interchangeable components although in at least one preferred embodiment, the tank is filled with water or arranged to be filled with water as opposed to any liquid when water tank is used). A method 400 is described and illustrated with respect to FIG. 18. In some embodiments, the method 400 may be used to prepare a foamless cushion.

Method 400 includes forming 402 a funnel assembly by (i) covering an inner surface (e.g. inner surface of walls 100 and/or 232) of a funnel (e.g. 26 and/or 204) with a liner (e.g. 120 and/or 244) comprising one or more elastic panels (e.g. 122), and/or (ii) connecting one or more actuators (e.g. 234; linear actuators, and/or linear servo motors; electromechanical; hydraulic; and/or pneumatic actuators) to one or more movable surfaces (e.g. 212-230) of the funnel. The method 400 also includes discharging 404 a plurality of polymeric filaments (e.g. 302) through the funnel of the funnel assembly. In some embodiments, the filaments may be discharged such that the filaments form a first shape or a second shape or other predetermined shape based on a position of the movable surfaces, and/or form a stranded mesh material member, e.g. 80, 92, and/or 94; consolidated filament structure, filament structure, mesh, extruded material, cushion blank, thermoplastic cushion, mesh cushion, seat cushion, or cushion.

In some embodiments, the method 400 includes that the funnel (e.g. 26 and/or 204) may be formed via shaped sheet metal, 3-D printed, and/or milled; the funnel may have a non-rectangular shape or complex geometry, including convex and concave shapes, planar sections as well as curves; and/or the funnel may be fixed or non-movable, or have one or more sections (e.g. 212) that moves. In some embodiments, and for the method 400, the one or more elastic panels (e.g. 122) may be panels with 2-way or 4-way stretch, and/or material with 15% stretch; the liner may be stretched when covering the funnel, e.g. stretched over the inner wall to remove wrinkles and make smooth, and/or steaming to remove wrinkles; the liner may be fastened to the funnel and/or the liner to connect the liner to the funnel, e.g. via fasteners (e.g. 140, 142, 144, and/or 150) such as staples, clips, grommets to hooks, sewn in wire/bead to hooks, hook and loop, tape, J-retainer, and/or tags; and/or the liner may be wrapped around the funnel and fastened it to itself and/or may be fastened to the funnel itself, e.g. by connecting to corresponding fasteners on the funnel such as staples, clips, grommets to hooks, sewn in wire/bead to hooks, hook and loop, tape, J-retainer, and/or tag.

In some embodiments, connecting the one or more actuators (e.g. 234) includes where actuating (e.g. 304) the actuators moves (e.g. 306) an associated movable surface between first and second positions; and/or the actuators may be actuated, e.g. via a connector (e.g. 235, 238 and/or 240; such as shafts and/or rods, and/or long finger-like portions extending between funnel and actuators, and/or gears or transmission), and/or via a controller (e.g. 255), based on a line speed or linear speed of the filament.

In some embodiments, and for method 400, discharging 404 a plurality of polymeric filaments (e.g. 302) may be via heating a polymeric material (e.g. 14) by linear low-density polyethylene (LLDPE) to a molten state, such that it becomes the molten polymer where heating may be in an extruder, rotating screw extruder, and/or via optional heating elements (e.g. 16 and/or 202), and/or introducing the molten polymer into a die or die plate or nozzle (e.g. 18 and/or 206) having a plurality of holes or orifices (e.g. 21) disposed therethrough such that the molten polymer moves through the holes and forms the plurality of strands as molten polymeric filaments, strands, and/or generally linear polymeric units (e.g. 24 and/or 208) that may be looped, fused or bonded together to form a mesh-like structure (e.g. 32). In some embodiments, the method 400 further comprises wetting the liner (e.g. by metering lubricant or fluid to the funnel and liner based on a line speed or linear speed of the filament and/or via a fluid system 36 with a hose 38 and/or via spigots 246).

In some embodiments, the method 400 further comprises introducing the molten polymeric filaments into a bath (e.g. 34 and/or 210; fluid chamber, cooling chamber, and/or heat transfer chamber) to cool the molten polymeric filaments upon exiting the funnel, where cooling may cause the strands to bond as the contoured unitary mesh product. In some embodiments, the method 400 further comprises cutting (e.g. 312) the stranded mesh material member to form at least one of a vehicle interior component (e.g. 90, 92, and/or 94; seat assembly, seat, or chair may refer to the same or similar assemblies, seat bottoms, backs, bases, head restraints, headrests, or bolsters may be used herein to refer generally to any component, region or portion of a vehicle interior component, a seat assembly, vehicle seat, or chair; or a unitary non-woven cushion, e.g. cushion blank, thermoplastic cushion, mesh cushion, seat cushion, or cushion). In some embodiments, the method 400 further comprises forming a product from the stranded mesh material, and installing the product on a seat frame as a seat cushion. In some embodiments, and for method 400, a seat assembly 90 or a product may be formed or manufactured according to the method.

In some embodiments, the method 400 where forming (e.g. 402) the funnel assembly further comprises actuating (e.g. 304) the one or more actuators (e.g. 234; linear actuators, and/or linear servo motors; electromechanical; hydraulic; and/or pneumatic actuators) cooperating with the funnel (e.g. 26 and/or 204) such that the one or more actuators moves (e.g. 306) an associated movable surface (e.g. 212-230) of the funnel from a first position to a second position. In some embodiments, the funnel may be formed via shaped sheet metal, 3-D printed, and/or milled; the funnel may have a non-rectangular shape or complex geometry, including convex and concave shapes, planar sections as well as curves; and/or the funnel may be fixed or non-movable, or have one or more sections (e.g. 212) that moves.

In some embodiments, the method 400 further comprises actuating (e.g. 304) the one or more actuators (e.g. 234; linear actuators, and/or linear servo motors; electromechanical; hydraulic; and/or pneumatic actuators) such that the movable surfaces (e.g. 212-230) are moved (e.g. 306) from the second position back to the first position.

In some embodiments, the method 400 includes that the plurality of polymeric filaments (e.g. 24 and/or 208) forms a first shape upon exiting the funnel (e.g. 26 and/or 204) based on a first position of the one or more movable surfaces (e.g. 212-230).

In some embodiments, the method 400 includes that the plurality of polymeric filaments (e.g. 24 and/or 208) forms a second shape different than the first shape upon exiting the funnel (e.g. 26 and/or 204) based on the second position.

In some embodiments, the method 400 further comprises actuating (e.g. 304) the one or more actuators (e.g. 234) based on a line speed (e.g. via a controller 255 and/or based on a linear speed for the filament).

In some embodiments, the method 400 further comprises wetting (e.g. via a fluid system 36 with a hose 38 and/or via spigots 246) the liner (e.g. 120 and/or 244).

In some embodiments, the method 400 further comprises metering lubricant to the funnel (e.g. 26 and/or 204) based on a line speed (e.g. via a controller 255 and/or based on a linear speed for the filament).

In some embodiments, the method 400 further comprises stretching the liner (e.g. 120 and/or 244) when covering the funnel (e.g. 26 and/or 204).

In some embodiments, the method 400 further comprises stretching the liner (e.g. 120 and/or 244) when covering the funnel (e.g. 26 and/or 204).

In some embodiments, the method 400 comprises fastening the liner (e.g. 120 and/or 244) to at least one of the funnel (e.g. 26 and/or 204) and/or the liner to connect the liner to the funnel. In some embodiments, fasteners (e.g. 140, 142, 144, and/or 150) such as staples, clips, grommets to hooks, sewn in wire/bead to hooks, hook and loop, tape, J-retainer, and/or tags may be used; and/or the liner may be wrapped around the funnel and fastened it to itself and/or may be fastened to the funnel itself, e.g. by connecting to corresponding fasteners on the funnel such as staples, clips, grommets to hooks, sewn in wire/bead to hooks, hook and loop, tape, J-retainer, and/or tag).

In some embodiments, the method 400 further comprises heating a polymeric material. The method 400 also includes introducing the molten polymer into a die plate (e.g. e.g. 18 and/or 206) having a plurality of holes (e.g. 21) disposed therethrough such that the molten polymer moves through the holes and forms the plurality of strands as molten polymeric filaments (e.g. 24 and/or 208). The method 400 also includes introducing the molten polymeric filaments (e.g. 24 and/or 208) into a bath (e.g. 34 and/or 210; fluid chamber, cooling chamber, and/or heat transfer chamber) to cool the molten polymeric filaments upon exiting the funnel. In some embodiments, heating a polymeric material (e.g. 14; linear low-density polyethylene (LLDPE) to a molten state, such that it becomes the molten polymer where heating may be in an extruder, rotating screw extruder, and/or via optional heating elements (e.g. 16 and/or 202).

In some embodiments, the method 400 further comprises cooling (e.g. via cooling in fluid in fluid bath) the plurality of strands (e.g. 24 and/or 208) to bond as the contoured unitary mesh product (e.g. 32).

In some embodiments, the method 400 further comprises cooling the plurality of strands (e.g. 24 and/or 208) in a fluid chamber (e.g. 34 and/or 210; cooling chamber, bath, and/or heat transfer chamber).

In some embodiments, the method 400 further comprises forming a stranded mesh material member (e.g. 80, 92, and/or 94) by extruding material from a die (e.g. 18 and/or 206) and through the funnel (e.g. 26 and/or 204). In some embodiments, the stranded mesh material member (e.g. 80, 92, and/or 94) may be a consolidated filament structure, filament structure, mesh, extruded material, cushion blank, thermoplastic cushion, mesh cushion, seat cushion, and/or cushion.

In some embodiments, the method 400 further comprises cutting (e.g. 312) the stranded mesh material member to form at least one of a vehicle interior component or a unitary non-woven cushion (e.g. 90, 92, and/or 94).; seat assembly, seat, or chair may refer to the same or similar assemblies, seat bottoms, backs, bases, head restraints, headrests, or bolsters may be used herein to refer generally to any component, region or portion of a vehicle interior component, a seat assembly, vehicle seat, or chair, or a unitary non-woven cushion, e.g. cushion blank, thermoplastic cushion, mesh cushion, seat cushion, or cushion). In some embodiments, the vehicle interior component or a unitary non-woven cushion (e.g. 90, 92, and/or 94) may be a seat assembly, seat, or chair may refer to the same or similar assemblies, seat bottoms, backs, bases, head restraints, headrests, or bolsters may be used herein to refer generally to any component, region or portion of a vehicle interior component, a seat assembly, vehicle seat, or chair, or a unitary non-woven cushion, e.g. cushion blank, thermoplastic cushion, mesh cushion, seat cushion, or cushion.

In some embodiments, a vehicle interior component (e.g. 90, 92, and/or 94). is formed by the method 400. In some embodiments, the vehicle interior component or a unitary non-woven cushion (e.g. 90, 92, and/or 94) may be a seat assembly, seat, or chair may refer to the same or similar assemblies, seat bottoms, backs, bases, head restraints, headrests, or bolsters may be used herein to refer generally to any component, region or portion of a vehicle interior component, a seat assembly, vehicle seat, or chair, or a unitary non-woven cushion, e.g. cushion blank, thermoplastic cushion, mesh cushion, seat cushion, or cushion.

In some embodiments, a stranded mesh material member (e.g. 80, 92, and/or 94; consolidated filament structure, filament structure, mesh, extruded material, cushion blank, thermoplastic cushion, mesh cushion, seat cushion, and/or cushion) is formed using the method 400.

In some embodiments, and for method 400, the stranded mesh material member forms a product. The method 400 further comprises installing the product on a seat frame (e.g. of a seat assembly 90) as a seat cushion.

In some embodiments, a seat assembly (e.g. 90) is formed using the method 400.

In some embodiments, a product is manufactured according to the method 400.

An assembly is described. The assembly (e.g. 50) includes a funnel (e.g. 26 and/or 204) comprising one or more side walls (e.g. 100 and/or 232) extending from an entrance (e.g. 28) to an outlet (e.g. 30). The assembly (e.g. 50) further comprises (i) a liner (e.g. 120 and/or 244) comprising one or more elastic panels (e.g. 122), with the liner extending over (e.g. covering) an inner surface of the one or more side walls, and/or (ii) one or more actuators (e.g. 234; linear actuators, and/or linear servo motors; electromechanical; hydraulic; and/or pneumatic actuators] cooperating with the one or more side walls, wherein at least one side wall of the one or more side walls comprise a plurality of movable sections (e.g. 212-230) cooperating to define an opening for the funnel, and wherein one of the entrance and the outlet define the opening, such that the one or more actuators when actuated (e.g. 304) to move (e.g. 306) the plurality of movable sections from a first position to a second position such that the opening changes from a first shape to a second shape. In some embodiments, the assembly may be a dynamic shaping tool and/or for shaping foamless cushions.

For the assembly, and in some embodiments, the funnel (e.g. 26 and/or 204) may be shaped sheet metal, 3-D printed, and/or milled; the one or more side walls (e.g. 100 and/or 232) may be non-rectangular shape, includes convex and concave shapes or surfaces, planar sections as well as curves (e.g. 104, 106, 108, and/or 110); and/or be fixed (non-movable), or have one section (e.g. 212-230) that moves. In some embodiments, the outlet (e.g. 30) may have a smaller cross-sectional area than the entrance (e.g. 28), and/or have the same general cross-sectional shape, e.g. with both shapes to form overall cross-sectional shape of the extruded member.

For the assembly, and in some embodiments, the one or more elastic panels (e.g. 122) include 2-way or 4-way stretch, material with 15% stretch; knit fabric and/or a polyester elastic material, elastane, nylon, natural fiber, and/or rubber core yarn. In some embodiments, the liner (e.g. 120 and/or 244) may also include non-elastic panels (e.g. 124) such as duon (e.g. for use with any fasteners) or duck cloth, and/or mix of elastic and non-elastic panels may be used to form the liner. In some embodiments, and for the assembly, the liner (e.g. 120 and/or 244) comprises an inner edge (e.g. 130) defining an aperture (e.g. 134) therethrough, and extends outwardly from the inner edge to an outer edge (e.g. 132), e.g. both edges may be cut to match entrance and outlet shape; the liner is a single panel (e.g. cut from a single sheet of material), or the liner is multiple panels connected to one another for more complex funnel shapes. In some embodiments, the liner (e.g. 120 and/or 244) extends over or covers an inner surface (e.g. inner surface of walls 100 and/or 232), and/or the liner cooperates with the side walls (e.g. 100 and/or 232) to define first and second shapes.

For the assembly, and in some embodiments, one or more fasteners (e.g. 140, 142, 144, and/or 150) may be provided and connected to the liner., In some embodiments, the fasteners are staples, clips, grommets to hooks, sewn in wire/bead to hooks, hook and loop, tape, J-retainer, and/or tape. In some embodiments, the fasteners (e.g. 140, 142, 144, and/or 150) may be first fasteners (e.g. 140) and connected to the liner adjacent the outer edge (e.g. 30) and/or second fasteners (e.g. 142) and connected to the liner adjacent to the inner edge (e.g. 28). In some embodiments, the first fasteners may connect to the second fasteners, e.g. by wrapping the liner around the funnel and fastening it to itself, and/or each first fastener and each second fastener connects to the funnel, e.g. by fastening the liner to the funnel itself and connecting the fasteners (1.g. 140, 142) to corresponding fasteners (e.g. 150) on the funnel, e.g. with each first fastener connecting to the funnel adjacent to the entrance, and each second fastener connecting to the funnel adjacent to the outlet.

For the assembly, and in some embodiments, the movable sections (e.g. 212-230) are a slide; and/or are disposed along one or more sides, a first side of the opening, or more than one side, or all sides or each sides. In some embodiments, each movable section (e.g. 212-230) has a shaping portion (e.g. 211) such as a triangular portion forming shaped funnel; and/or a connector (e.g. 235, 238 and/or 240; such as shafts and/or rods, and/or long finger-like portions extending between funnel and actuators, and/or gears or transmission) that cooperates with the one or more actuators and shaping portion such that the one or more actuators moves the associated one or more shaping portions when actuated. In some embodiments, the movable sections (e.g. 212-230) may cooperate with a guide and/or a track (e.g. 248 and/or 250) for translation of the movable section and/or to direct movement of the movable sections when the actuator is actuated. In some embodiments, each movable section (e.g. 212-230) cooperates with a lubricating system (e.g. 36, and/or 205) such as a fluid bath or water bath; the lubricating system may have a lubricating spigot (e.g. 246) to cooperate with each movable section (e.g. 212-230); and/or the lubricating spigot is at least partially disposed in the movable section, e.g. as an integrated nozzle in a slide, and/or with the lubricating spigot be positioned between the movable section and the liner to provide lubricant from beneath the liner; and/or a controller (e.g. 255) may be programmed to meter lubricant to the funnel based on a line speed or linear speed of the filament.

For the assembly and in some embodiments, each actuator (e.g. 234) may be connected to a respective one of the movable sections (e.g. 212-230) and/or to a group of movable sections. In some embodiments, the actuators (e.g. 234) may cooperate with a shaft (e.g. 238) such that the actuator moves from a first position to a second position when the shaft rotates. In some embodiments, the actuators (e.g. 234) are actuated via a controller (e.g. 255) programmed to actuate the one or more actuators from a first predetermined shape to a second predetermined shape, e.g. based on a line speed or linear speed for the filament. In some embodiments, the opening of the funnel (e.g. 26 and/or 204) changes from a first shape to a second shape, e.g. with the shapes predetermined, the first shape comprises a straight, concave, or convex edge (104, 106, 108, and/or 110) formed by the plurality of movable sections and the second shape comprises a different concave or convex edge (104, 106, 108, and/or 110) formed by the plurality of movable sections.

In some embodiments, the assembly has a fluid bath (e.g. 36, 205, and/or 210) with the funnel positioned with the outlet (e.g. 30) submerged in the fluid bath, and the entrance (e.g. 28) positioned outside the fluid bath and above the outlet. In some embodiments, the fluid bath (e.g. 36, 205, and/or 210) may include at least one hose (e.g. 38) in fluid communication with the fluid bath and positioned adjacent to the entrance (e.g. 28) of the funnel to wet the liner; and the hose may be provided with multiple outlets such as a soaker hose, and/or with spray nozzles. In some embodiments, the assembly (e.g. 50) may further include a system (e.g. 10, 200) with a dispenser (e.g. 16, 202), e.g. as a die positioned adjacent to the entrance to the funnel, with the die comprising a series of apertures therethrough, and/or the assembly positioned relative to the dispenser to receive and shape the strands (e.g. 24, 208) of molten polymeric resin.

In some embodiments, the assembly (e.g. 50) further comprises the liner (e.g. 120 and/or 244) and the one or more actuators (e.g. 234).

In some embodiments, the assembly (e.g. 50) has that the liner (e.g. 120 and/or 244) cooperates with the movable sections (e.g. 212-230) to define the first and second shapes.

In some embodiments, the assembly (e.g. 50) includes the plurality of movable sections (e.g. 234) disposed along a first side of the opening. In some embodiments, the movable sections may be provided along more than one side or all sides of the opening.

In some embodiments, the assembly (e.g. 50) includes the plurality of movable sections (e.g. 234) disposed along one or more sides of the opening. In some embodiments, the movable sections may be provided along more than one side or all sides of the opening.

In some embodiments, the assembly (e.g. 50) includes the plurality of movable sections (e.g. 234) disposed along each side of the opening.

In some embodiments, the assembly (e.g. 50) includes each actuator (e.g. 234) of the plurality of actuators being independently actuated.

In some embodiments, and for the assembly (e.g. 50), each actuator (e.g. 234) is a linear actuator.

In some embodiments, and for the assembly (e.g. 50), each actuator (e.g. 234) is connected to a respective one of the movable sections (e.g. 212-230).

In some embodiments, and for the assembly (e.g. 50), an actuator (e.g. 234) of the one or more actuators is connected to a group of the movable sections (e.g. 212-230).

In some embodiments, and for the assembly (e.g. 50), the one or more actuators (e.g. 234) cooperate with a shaft (e.g. 238) such that when the shaft rotates the one or more actuators move from a first position to a second position. In some embodiments, the shaft (e.g. 238) is a camshaft and/or a crankshaft.

In some embodiments, and for the assembly (e.g. 50), the first shape comprises a straight, concave, or convex edge (e.g. 104, 106, 108, 110) formed by the plurality of movable sections (e.g. 212-230) and the second shape comprises a different concave or convex edge formed by the plurality of movable sections.

In some embodiments, and for the assembly (e.g. 50), each movable section (e.g. 212-230) cooperates with a lubricating system (e.g. 36, and/or 205), e.g. a fluid system and/or a water bath.

In some embodiments, and for the assembly (e.g. 50), each movable section (e.g. 212-230) cooperates with a respective lubricating spigot (e.g. 245), e.g. an integrated nozzle in a slide of the movable section.

In some embodiments, and for the assembly (e.g. 50), the lubricating spigot (e.g. 246) is at least partially disposed in the movable section (e.g. 212-230).

In some embodiments, and for the assembly (e.g. 50), the lubricating spigot (e.g. 246) is positioned between the movable section (e.g. 212-230) and the liner (e.g. 120 and/or 244) to provide the lubricant from beneath the liner.

In some embodiments, and for the assembly (e.g. 50), each movable section (e.g. 212-230) comprises a shaping portion (e.g. 211), e.g. a triangular portion, and a connector (e.g. 240). e.g. shafts, rods, and/or long finger-like portions extending between the funnel and actuators, that cooperates with the one or more actuators and shaping portion such that the one or more actuators moves the associated one or more shaping portions when actuated.

In some embodiments, and for the assembly (e.g. 50), the plurality of movable section (e.g. 212-230) cooperates with a guide (e.g. 248), e.g. a track (e.g. 250), to direct movement of the plurality of movable sections when the actuator (e.g. 234) is actuated.

In some embodiments, and for the assembly (e.g. 50), the guide (e.g. 248) is a track (e.g. 250, 252, and/or 254) such that each movable section (e.g. 212-230) translates along the track when actuated.

In some embodiments, the assembly (e.g. 50), further comprises a controller (e.g. 255) programmed to actuate the one or more actuators (e.g. 234) from a first predetermined shape to a second predetermined shape.

In some embodiments, and for the assembly (e.g. 50), the controller (e.g. 255) is programmed to actuate from a first predetermined shape to a second predetermined shape based on a line speed, e.g. a linear speed for the filament (e.g. 24, 208).

In some embodiments, and for the assembly (e.g. 50), the controller (e.g. 255) is programmed to meter lubricant to the funnel (e.g. 26 and/or 204) based on a line speed, e.g. a linear speed for the filament (e.g. 24, 208).

In some embodiments, and for the assembly (e.g. 50), the liner (e.g. 120 and/or 244) comprises an inner edge (e.g. 130) defining an aperture (e.g. 134) therethrough, and extends outwardly from the inner edge to an outer edge (e.g. 132), e.g. both edges may be cut to match entrance and outlet shape.

In some embodiments, and for the assembly (e.g. 50), the liner (e.g. 120 and/or 244) comprises a single panel, e.g. cut from a single sheet of material, or the liner is multiple panels connected to one another for more complex funnel shapes. In some embodiments, the assembly (e.g. 50) further comprises one or more first fasteners (e.g. 140), e.g. staples, clips, grommets to hooks, sewn in wire/bead to hooks, hook and loop, tape, J-retainer, and/or tag, connected to the liner adjacent to the outer edge (e.g. 132).

In some embodiments, the assembly (e.g. 50) further comprises one or more second fasteners (e.g. 142), e.g. staples, clips, grommets to hooks, sewn in wire/bead to hooks, hook and loop, tape, J-retainer, and/or tag, connected to the liner adjacent to the inner edge (e.g. 130).

In some embodiments, and for the assembly (e.g. 50), the one or more elastic panels (e.g. 122) comprise a knit fabric.

In some embodiments, and for the assembly (e.g. 50), the one or more elastic panels (e.g. 122) comprises at least one of a polyester elastic material, elastane, nylon, natural fiber, and/or rubber core yarn.

In some embodiments, and for the assembly (e.g. 50), the liner (e.g. 120 and/or 244) further comprises one or more non-elastic panels, e.g. duon, and/or duck cloth; and/or a mix of elastic and non-elastic panels to form the liner.

In some embodiments, and for the assembly (e.g. 50), the liner (e.g. 120 and/or 244) comprises an inner edge (e.g. 130) defining an aperture (e.g. 134) therethrough, and extends outwardly from the inner edge to an outer edge (e.g. 132), e.g. both edges may be cut to match entrance and outlet shape.

In some embodiments, and for the assembly (e.g. 50), the liner (e.g. 120 and/or 244) comprises a single panel, e.g. cut from a single sheet of material, or the liner is multiple panels connected to one another for more complex funnel shapes.

In some embodiments, the assembly (e.g. 50) further comprises one or more first fasteners (e.g. 140), e.g. staples, clips, grommets to hooks, sewn in wire/bead to hooks, hook and loop, tape, J-retainer, and/or tag, connected to the liner adjacent to the outer edge (e.g. 132).

In some embodiments, the assembly (e.g. 50) further comprises one or more second fasteners (e.g. 142), e.g. staples, clips, grommets to hooks, sewn in wire/bead to hooks, hook and loop, tape, J-retainer, and/or tag, connected to the liner adjacent to the inner edge (e.g. 130).

In some embodiments, and for the assembly (e.g. 50), each first fastener (e.g. 140) connects to a respective one of the second fasteners (e.g. 142), e.g. by wrapping the liner around the funnel and fastening it to itself.

In some embodiments, and for the assembly (e.g. 50), each first fastener (e.g. 140) and each second fastener (e.g. 142) connects to the funnel (e.g. 26 and/or 204), e.g. by fastening the liner to the funnel itself and connecting to corresponding fasteners (e.g. 150) on the funnel such as staples, clips, grommets to hooks, sewn in wire/bead to hooks, hook and loop, tape, J-retainer, and/or tape.

In some embodiments, and for the assembly (e.g. 50), each first fastener (e.g. 140) connects to the funnel (e.g. 26 and/or 204) adjacent to the entrance (e.g. 28), and wherein each second fastener (e.g. 142) connects to the funnel (e.g. 26 and/or 204) adjacent to the outlet (e.g. 30).

In some embodiments, and for the assembly (e.g. 50), the one or more elastic panels (e.g. 122) comprise a knit fabric.

In some embodiments, and for the assembly (e.g. 50), the one or more elastic panels (e.g. 122) comprises at least one of a polyester elastic material, elastane, nylon, natural fiber, and/or rubber core yarn.

In some embodiments, and for the assembly (e.g. 50), the liner (e.g. 120 and/or 244) further comprises one or more non-elastic panels, e.g. duon, and/or duck cloth; and/or a mix of elastic and non-elastic panels to form the liner.

In some embodiments, and for the assembly (e.g. 50), the one or more side walls (e.g. 100 and/or 232) of the funnel define at least one concave surface (e.g. 104) and at least one convex surface (e.g. 106), e.g. as a complex shape.

In some embodiments, and for the assembly (e.g. 50), the liner (e.g. 120 and/or 244) cooperates with the movable sections (e.g. 234) to define the first and second shapes.

In some embodiments, the assembly (e.g. 50) includes the plurality of movable sections (e.g. 234) disposed along a first side of the opening. In some embodiments, the movable sections may be provided along more than one side or all sides of the opening.

In some embodiments, the assembly (e.g. 50) includes the plurality of movable sections (e.g. 234) disposed along one or more sides of the opening. In some embodiments, the movable sections may be provided along more than one side or all sides of the opening.

In some embodiments, the assembly (e.g. 50) includes the plurality of movable sections (e.g. 234) disposed along each side of the opening.

In some embodiments, the assembly (e.g. 50) includes each actuator (e.g. 234) of the plurality of actuators being independently actuated.

In some embodiments, and for the assembly (e.g. 50), each actuator (e.g. 234) is a linear actuator.

In some embodiments, and for the assembly (e.g. 50), each actuator (e.g. 234) is connected to a respective one of the movable sections (e.g. 212-230).

In some embodiments, and for the assembly (e.g. 50), an actuator (e.g. 234) of the one or more actuators is connected to a group of the movable sections (e.g. 212-230).

In some embodiments, and for the assembly (e.g. 50), the one or more actuators (e.g. 234) cooperate with a shaft (e.g. 238) such that when the shaft rotates the one or more actuators move from a first position to a second position. In some embodiments, the shaft (e.g. 238) is a camshaft and/or a crankshaft.

In some embodiments, and for the assembly (e.g. 50), the first shape comprises a straight, concave, or convex edge (e.g. 104, 106, 108, 110) formed by the plurality of movable sections (e.g. 212-230) and the second shape comprises a different concave or convex edge formed by the plurality of movable sections.

In some embodiments, and for the assembly (e.g. 50), each movable section (e.g. 212-230) comprises a shaping portion (e.g. 211), e.g. a triangular portion, and a connector (e.g. 240). e.g. shafts, rods, and/or long finger-like portions extending between the funnel and actuators, that cooperates with the one or more actuators and shaping portion such that the one or more actuators moves the associated one or more shaping portions when actuated.

In some embodiments, and for the assembly (e.g. 50), the plurality of movable section (e.g. 212-230) cooperates with a guide (e.g. 248), e.g. a track (e.g. 250), to direct movement of the plurality of movable sections when the actuator (e.g. 234) is actuated.

In some embodiments, and for the assembly (e.g. 50), the guide (e.g. 248) is a track (e.g. 250, 252, and/or 254) such that each movable section (e.g. 212-230) translates along the track when actuated.

In some embodiments, the assembly (e.g. 50), further comprises a controller (e.g. 255) programmed to actuate the one or more actuators (e.g. 234) from a first predetermined shape to a second predetermined shape.

In some embodiments, and for the assembly (e.g. 50), the controller (e.g. 255) is programmed to actuate from a first predetermined shape to a second predetermined shape based on a line speed, e.g. a linear speed for the filament (e.g. 24, 208).

In some embodiments, and for the assembly (e.g. 50), the controller (e.g. 255) is programmed to meter lubricant to the funnel (e.g. 26 and/or 204) based on a line speed, e.g. a linear speed for the filament (e.g. 24, 208).

In some embodiments, and for the assembly (e.g. 50), each movable section (e.g. 212-230) cooperates with a lubricating system (e.g. 36, and/or 205), e.g. a fluid system and/or a water bath.

In some embodiments, and for the assembly (e.g. 50), each movable section (e.g. 212-230) cooperates with a respective lubricating spigot (e.g. 245), e.g. an integrated nozzle in a slide of the movable section.

In some embodiments, and for the assembly (e.g. 50), the lubricating spigot (e.g. 246) is at least partially disposed in the movable section (e.g. 212-230).

In some embodiments, and for the assembly (e.g. 50), the lubricating spigot (e.g. 246) is positioned between the movable section (e.g. 212-230) and the liner (e.g. 120 and/or 244) to provide the lubricant from beneath the liner.

In some embodiments, and for the assembly (e.g. 50), each actuator (e.g. 234; linear actuators, and/or linear servo motors; electromechanical; hydraulic; and/or pneumatic actuators) of the one or more actuators is connected to a respective one of the movable sections (e.g. 212-230), or the one or more actuators (e.g. 234) cooperate with a shaft (e.g. 238; camshaft and/or crankshaft) such that when the shaft rotates the one or more actuators move from a first position to a second position; and/or each movable section (e.g. 212-230) cooperates with a respective lubricating spigot (e.g. 246) of a lubricating system.

In some embodiments, and for the assembly (e.g. 50), each actuator (e.g. 234; linear actuators, and/or linear servo motors; electromechanical; hydraulic; and/or pneumatic actuators) of the one or more actuators is connected to a respective one of the movable sections (e.g. 212-230), or the one or more actuators (e.g. 234) cooperate with a shaft (e.g. 238; camshaft and/or crankshaft) such that when the shaft rotates the one or more actuators move from a first position to a second position; and/or each movable section (e.g. 212-230) cooperates with a respective lubricating spigot (e.g. 246) of a lubricating system.

In some embodiments, the assembly (e.g. 50) further comprises a fluid bath (e.g. 36, 205, and/or 210) with the funnel positioned with the outlet (e.g. 30) submerged in the fluid bath, and the entrance (e.g. 28) positioned outside the fluid bath and above the outlet.

In some embodiments, the assembly (e.g. 50) further comprises at least one hose (e.g. 38) in fluid communication with the fluid bath and positioned adjacent to the entrance (e.g. 28) of the funnel to wet the liner; and the hose may be provided with multiple outlets such as a soaker hose, and/or with spray nozzles.

In some embodiments, the assembly (e.g. 50) further comprises a die (e.g. 16, 202) positioned adjacent to the entrance (e.g. 28) to the funnel, the die comprising a series of apertures (e.g. 21 and/or 206; e.g. nozzles) therethrough.

In some embodiments, a system (e.g. 10, 200) comprises a dispenser (e.g. 16, 202), e.g. as a die positioned adjacent to the entrance to the funnel, with the die comprising a series of apertures therethrough, and the assembly (e.g. 50) oriented relative to the dispenser to receive and shape the plurality of strands (e.g. 24, 208).

A system is described. The system (e.g. 10, 200) comprises a dispenser (e.g. 16, 202), e.g. die and/or plurality of nozzles, to dispense a plurality of polymeric filaments (e.g. 24, 208). The system (e.g. 10, 200) also comprises a funnel assembly comprising a funnel (e.g. 26 and/or 204) comprising one or more side walls (e.g. 100 and/or 232) extending from an entrance (e.g. 28) to an outlet (e.g. 30) with the entrance positioned to receive polymeric filaments (e.g. 24, 208) extruded from the dispenser. The funnel assembly further comprises at least one of: a liner (e.g. 120 and/or 244) comprising one or more elastic panels (e.g. 122) with the liner extending over an inner surface of the one or more side walls; or one or more movable sections (e.g. 212-230) forming at least one side wall (e.g. 100 and/or 232) of the one or more side walls and cooperating to define an opening for the funnel, wherein one of the entrance (e.g. 28) and the outlet (e.g. 30) define the opening.

In some embodiments, and for the system (10, 200), the actuators (e.g. 234) are linear actuators, and/or linear servo motors; electromechanical; hydraulic; and/or pneumatic actuators. In some embodiments, the actuators (e.g. 234) cooperate with the one or more movable sections (e.g. 212-230) such that the one or more actuators, when actuated, move the one or more movable sections from a first position to a second position such that the opening changes from a first shape to a second shape. In some embodiments, the one or more actuators (e.g. 234) cooperate with a shaft (e.g. 238) such that rotation of the shaft moves the actuators (e.g. 234) from a first position to a second position. In some embodiments, each movable section (e.g. 212-230) cooperates with a lubricating system (e.g. 36, and/or 205) such as a fluid bath or water bath; the lubricating system may have a lubricating spigot (e.g. 246) to cooperate with each movable section (e.g. 212-230); and/or the lubricating spigot is at least partially disposed in the movable section, e.g. as an integrated nozzle in a slide, and/or with the lubricating spigot be positioned between the movable section and the liner to provide lubricant from beneath the liner; and/or a controller (e.g. 255) may be programmed to meter lubricant to the funnel based on a line speed or linear speed of the filament.

In some embodiments, the assembly has a fluid bath (e.g. 36, 205, and/or 210) with the funnel positioned with the outlet (e.g. 30) submerged in the fluid bath to receive filaments from the funnel, and the entrance (e.g. 28) positioned outside the fluid bath and above the outlet. In some embodiments, the fluid bath (e.g. 36, 205, and/or 210) may include at least one hose (e.g. 38) in fluid communication with the fluid bath and positioned adjacent to the entrance (e.g. 28) of the funnel to wet the liner; and the hose may be provided with multiple outlets such as a soaker hose, and/or with spray nozzles. In some embodiments, the system (e.g. 10, 200) has a conveyor assembly (e.g. 62, 64, 66) provided in the cooling bath to move the filaments (e.g. 24, 208).

In some embodiments, the liner for the system (10, 200) comprises one or more elastic panels (e.g. 122), e.g. 2-way or 4-way stretch, material with 15% stretch; knit fabric and/or a polyester elastic material, elastane, nylon, natural fiber, and/or rubber core yarn.

In some embodiments, the system (e.g. 10, 200) is provided for forming a cushion member from a stranded mesh material member (e.g. 80, 92, and/or 94), e.g. consolidated filament structure, filament structure, mesh, extruded material, cushion blank, thermoplastic cushion, mesh cushion, seat cushion, or cushion.

In some embodiments, the system (e.g. 10, 200) further comprises one or more actuators (e.g. 234; linear actuators, and/or linear servo motors; electromechanical; hydraulic; and/or pneumatic actuators) cooperating with the one or more movable sections (e.g. 212-230), such that the one or more actuators, when actuated, move the one or more movable sections from a first position to a second position such that the opening changes from a first shape to a second shape.

In some embodiments, and for the system (e.g. 10, 200) the one or more actuators (e.g. 234) comprise a linear actuator.

In some embodiments, and for the system (e.g. 10, 200), the one or more actuators (e.g. 234) cooperate with a shaft (e.g. 238; camshaft and/or crankshaft) such that when the shaft rotates the one or more actuators move from a first position to a second position.

In some embodiments, the system (e.g. 10, 200) further comprises a lubricating system (e.g. 36, and/or 205), e.g. a fluid system and/or a water bath, in cooperation with the one or more movable sections (e.g. 212-230).

In some embodiments, and for the system (e.g. 10, 200), the lubrication system comprises one or more lubricating spigots (e.g. 245), and each movable section (e.g. 212-230) cooperates with a respective lubricating spigot (e.g. 245), e.g. an integrated nozzle in a slide of the movable section.

In some embodiments, and for the system (e.g. 10, 200), the dispenser (e.g. 16, 202) comprises a die (e.g. 18).

In some embodiments, and for the system (e.g. 10, 200), the dispenser (e.g. 16, 202) comprises a plurality of nozzles (e.g. 206).

In some embodiments, the system (e.g. 10, 200) further comprises a fluid bath (e.g. 36, 205, and/or 210) with the outlet (e.g. 30) of the funnel submerged in the fluid bath, and the entrance (e.g. 28) positioned above the fluid in the fluid bath; and at least one hose (e.g. 38) to direct fluid from the fluid bath onto the liner.

In some embodiments, the system (e.g. 10, 200) further comprises a cooling bath (e.g. 36, 205, and/or 210) to receive the plurality of polymeric filaments (e.g. 24, 208) from the funnel.

In some embodiments, the system (e.g. 10, 200) further comprises a conveyor assembly (e.g. 62, 64, 66) cooperating with the cooling bath (e.g. 36, 205, and/or 210) to move the plurality of polymeric filaments (e.g. 24, 208).

Clause 1. An assembly, in combination with, or without, any one or more of the successive clauses, comprises a funnel comprising one or more side walls extending from an entrance to an outlet. The assembly is also provided with a liner comprising one or more elastic panels with the liner extending over an inner surface of the one or more side walls; and/or one or more actuators cooperating with the one or more side walls, where at least one side wall of the one or more side walls comprise a plurality of movable sections cooperating to define an opening for the funnel, and one of the entrance and the outlet define the opening, such that the one or more actuators, when actuated, move the plurality of movable sections from a first position to a second position such that the opening changes from a first shape to a second shape.

Clause 2. The assembly of any of the preceding or successive clauses further comprising the liner and the one or more actuators.

Clause 3. The assembly of any of the preceding or successive clauses, wherein the liner cooperates with the movable sections to define the first and second shapes.

Clause 4. The assembly of any of the preceding or successive clauses, wherein the plurality of movable sections is disposed along a first side of the opening.

Clause 5. The assembly of any of the preceding or successive clauses, wherein the plurality of movable sections is disposed one or more sides of the opening.

Clause 6. The assembly of any of the preceding or successive clauses, wherein the plurality of movable sections is disposed along each side of the opening.

Clause 7. The assembly of any of the preceding or successive clauses, wherein each actuator of the plurality of actuators is independently actuated.

Clause 8. The assembly of any of the preceding or successive clauses wherein each actuator is a linear actuator.

Clause 9. The assembly of any of the preceding or successive clauses wherein each actuator is connected to a respective one of the movable sections.

Clause 10. The assembly of any of the preceding or successive clauses wherein an actuator of the one or more actuators is connected to a group of the movable sections.

Clause 11. The assembly of any of the preceding or successive clauses wherein the one or more actuators cooperate with a shaft such that when the shaft rotates the one or more actuators move from a first position to a second position.

Clause 12. The assembly of any of the preceding or successive clauses, wherein the first shape comprises a straight, concave, or convex edge formed by the plurality of movable sections and the second shape comprises a different concave or convex edge formed by the plurality of movable sections.

Clause 13. The assembly of any of the preceding or successive clauses, wherein each movable section cooperates with a lubricating system.

Clause 14. The assembly of any of the preceding or successive clauses, wherein each movable section cooperates with a respective lubricating spigot.

Clause 15. The assembly of any of the preceding or successive clauses, wherein the lubricating spigot is at least partially disposed in the movable section.

Clause 16. The assembly of any of the preceding or successive clauses wherein the lubricating spigot is positioned between the movable section and the liner to provide the lubricant from beneath the liner.

Clause 17. The assembly of any of the preceding or successive clauses, wherein each movable section comprises a shaping portion and a connector that cooperates with the one or more actuators and shaping portion such that the one or more actuators moves the associated one or more shaping portions when actuated.

Clause 18. The assembly of any of the preceding or successive clauses, wherein the plurality of movable sections cooperates with a guide to direct movement of the plurality of movable sections when the actuator is actuated.

Clause 19. The assembly of any of the preceding or successive clauses wherein the guide is a track such that each movable section translates along the track when actuated. Clause 20. The assembly of any of the preceding or successive clauses, further comprising a controller programmed to actuate the one or more actuators from a first predetermined shape to a second predetermined shape.

Clause 21. The assembly of any of the preceding or successive clauses, wherein the controller is programmed to actuate from a first predetermined shape to a second predetermined shape based on a line speed.

Clause 22. The assembly of any of the preceding or successive clauses, wherein the controller is programmed to meter lubricant to the funnel based on a line speed.

Clause 23. The assembly of any of the preceding or successive clauses wherein the liner comprises an inner edge defining an aperture therethrough, and extends outwardly from the inner edge to an outer edge.

Clause 24. The assembly of any of the preceding or successive clauses wherein the liner comprises a single panel.

Clause 25. The assembly of any of the preceding or successive clauses further comprising one or more first fasteners connected to the liner adjacent to the outer edge.

Clause 26. The assembly of any of the preceding or successive clauses further comprising one or more second fasteners connected to the liner adjacent to the inner edge.

Clause 27. The assembly of any of the preceding or successive clauses wherein the one or more elastic panels comprise a knit fabric.

Clause 28. The assembly of any of the preceding or successive clauses wherein the one or more elastic panels comprises at least one of a polyester elastic material, elastane, nylon, natural fiber, and/or rubber core yarn.

Clause 29. The assembly of any of the preceding or successive clauses wherein the liner further comprises one or more non-elastic panels. Clause 30. The assembly of any of the preceding or successive clauses wherein the liner comprises an inner edge defining an aperture therethrough, and extends outwardly from the inner edge to an outer edge.

Clause 31. The assembly of any of the preceding or successive clauses wherein the liner comprises a single panel.

Clause 32. The assembly of any of the preceding or successive clauses further comprising one or more first fasteners connected to the liner adjacent to the outer edge.

Clause 33. The assembly of any of the preceding or successive clauses further comprising one or more second fasteners connected to the liner adjacent to the inner edge.

Clause 34. The assembly of any of the preceding or successive clauses wherein each first fastener connects to a respective one of the second fasteners.

Clause 35. The assembly of any of the preceding or successive clauses wherein each first fastener and each second fastener connects to the funnel.

Clause 36. The assembly of any of the preceding or successive clauses wherein each first fastener connects to the funnel adjacent to the entrance, and wherein each second fastener connects to the funnel adjacent to the outlet.

Clause 37. The assembly of any of the preceding or successive clauses wherein the one or more elastic panels comprise a knit fabric.

Clause 38. The assembly of any of the preceding or successive clauses wherein the one or more elastic panels comprises at least one of a polyester elastic material, elastane, nylon, natural fiber, and/or rubber core yarn.

Clause 39. The assembly of any of the preceding or successive clauses wherein the liner further comprises one or more non-elastic panels.

Clause 40. The assembly of any of the preceding or successive clauses wherein the one or more side walls of the funnel define at least one concave surface and at least one convex surface.

Clause 41. The assembly of any of the preceding or successive clauses, wherein the liner cooperates with the movable sections to define the first and second shapes.

Clause 42. The assembly of any of the preceding or successive clauses, wherein the plurality of movable sections is disposed along a first side of the opening.

Clause 43. The assembly of any of the preceding or successive clauses, wherein the plurality of movable sections is disposed along one or more sides of the opening.

Clause 44. The assembly of any of the preceding or successive clauses, wherein the plurality of movable sections is disposed along each side of the opening.

Clause 45. The assembly of any of the preceding or successive clauses, wherein each actuator of the plurality of actuators is independently actuated.

Clause 46. The assembly of any of the preceding or successive clauses wherein each actuator is a linear actuator.

Clause 47. The assembly of any of the preceding or successive clauses wherein each actuator is connected to a respective one of the movable sections.

Clause 48. The assembly of any of the preceding or successive clauses wherein an actuator of the one or more actuators is connected to a group of the movable sections.

Clause 49. The assembly of any of the preceding or successive clauses, wherein the one or more actuators cooperate with a shaft such that when the shaft rotates the one or more actuators move from a first position to a second position.

Clause 50. The assembly of any of the preceding or successive clauses, wherein the first shape comprises a straight, concave, or convex edge formed by the plurality of movable sections and the second shape comprises a different concave or convex edge formed by the plurality of movable sections.

Clause 51. The assembly of any of the preceding or successive clauses, wherein each movable section comprises a shaping portion and a connector that cooperates with the one or more actuators and shaping portion such that the one or more actuators moves the associated one or more shaping portions when actuated.

Clause 52. The assembly of any of the preceding or successive clauses, wherein the plurality of movable sections cooperates with a guide to direct movement of the plurality of movable sections when the actuator is actuated.

Clause 53. The assembly of any of the preceding or successive clauses wherein the guide is a track such that each movable section translates along the track when actuated.

Clause 54. The assembly of any of the preceding or successive clauses, further comprising a controller programmed to actuate the one or more actuators from a first predetermined shape to a second predetermined shape.

Clause 55. The assembly of any of the preceding or successive clauses, wherein the controller is programmed to actuate from a first predetermined shape to a second predetermined shape based on a line speed.

Clause 56. The assembly of any of the preceding or successive clauses, wherein the controller is programmed to meter lubricant to the funnel based on a line speed.

Clause 57. The assembly of any of the preceding or successive clauses, wherein each movable section cooperates with a lubricating system.

Clause 58. The assembly of any of the preceding or successive clauses, wherein each movable section cooperates with a respective lubricating spigot.

Clause 59. The assembly of any of the preceding or successive clauses, wherein the lubricating spigot is at least partially disposed in the movable section.

Clause 60. The assembly of any of the preceding or successive clauses, wherein the lubricating spigot is positioned between the movable section and the liner to provide the lubricant from beneath the liner.

Clause 61. The assembly of any of the preceding or successive clauses wherein each actuator of the one or more actuators is connected to a respective one of the movable sections, or the one or more actuators cooperate with a shaft such that when the shaft rotates the one or more actuators move from a first position to a second position; and/or each movable section cooperates with a respective lubricating spigot of a lubricating system.

Clause 62. The assembly of any of the preceding or successive clauses wherein each actuator of the one or more actuators is connected to a respective one of the movable sections, or the one or more actuators cooperate with a shaft such that when the shaft rotates the one or more actuators move from a first position to a second position; and/or each movable section cooperates with a respective lubricating spigot of a lubricating system.

Clause 63. The assembly of any of the preceding or successive clauses further comprising a fluid bath, wherein the funnel is positioned with the outlet submerged in the fluid bath, and the entrance positioned outside the fluid bath and above the outlet.

Clause 64. The assembly of any of the preceding or successive clauses further comprising at least one hose in fluid communication with the fluid bath and positioned adjacent to the entrance of the funnel to wet the liner.

Clause 65. The assembly of any of the preceding or successive clauses further comprising a die positioned adjacent to the entrance to the funnel, the die comprising a series of apertures therethrough.

Clause 66. A system comprising: a dispenser of a plurality of strands of molten thermoplastic resin; and the assembly of any of the preceding or successive clauses, oriented relative to the dispenser to receive and shape the plurality of strands.

Clause 67. A method in combination with, or without, any one or more of the successive clauses, comprises forming a funnel assembly by (i) covering an inner surface of a funnel with a liner comprising one or more elastic panels, and/or (ii) connecting one or more actuators to one or more movable surfaces of the funnel; and discharging a plurality of polymeric filaments through the funnel of the funnel assembly.

Clause 68. The method of any of the preceding or successive clauses wherein forming the funnel assembly further comprises actuating the one or more actuators cooperating with the funnel such that the one or more actuators moves an associated movable surface of the funnel from a first position to a second position.

Clause 69. The method of any of the preceding or successive clauses further comprising actuating the one or more actuators such that the movable surfaces are moved from the second position back to the first position.

Clause 70. The method of any of the preceding or successive clauses wherein the plurality of polymeric filaments forms a first shape upon exiting the funnel based on a first position of the one or more movable surfaces.

Clause 71. The method of any of the preceding or successive clauses wherein the plurality of polymeric filaments forms a second shape different than the first shape upon exiting the funnel based on the second position.

Clause 72. The method of any of the preceding or successive clauses further comprising actuating the one or more actuators based on a line speed.

Clause 73. The method of any of the preceding or successive clauses further comprising wetting the liner.

Clause 74. The method of any of the preceding or successive clauses further comprising metering lubricant to the funnel based on a line speed. [e.g. linear speed for the filament]

Clause 75. The method of any of the preceding or successive clauses further comprising stretching the liner when covering the funnel.

Clause 76. The method of any of the preceding or successive clauses further comprising: stretching [stretched over inner wall to remove wrinkles and make smooth, can further steam to remove wrinkles] the liner when covering the funnel.

Clause 77. The method of any of the preceding or successive clauses further comprising fastening the liner to at least one of the funnel and/or the liner to connect the liner to the funnel.

Clause 78. The method of any of the preceding or successive clauses further comprising: heating a polymeric material to a molten state, such that it becomes the molten polymer; introducing the molten polymer into a die plate having a plurality of holes disposed therethrough such that the molten polymer moves through the holes and forms the plurality of strands as molten polymeric filaments; and introducing the molten polymeric filaments into a bath to cool the molten polymeric filaments upon exiting the funnel.

Clause 79. The method of any of the preceding or successive clauses, further comprising cooling the plurality of strands to bond as the contoured unitary mesh product.

Clause 80. The method of any of the preceding or successive clauses, further comprising cooling the plurality of strands in a fluid chamber.

Clause 81. The method of any of the preceding or successive clauses further comprising forming a stranded mesh material member by extruding material from a die and through the funnel.

Clause 82. The method of any of the preceding or successive clauses further comprising: cutting the stranded mesh material member to form at least one of a vehicle interior component or a unitary non-woven cushion.

Clause 83. A vehicle interior component formed by the method of any of the preceding or successive clauses.

Clause 84. A stranded mesh material member formed using the method of any of the preceding or successive clauses.

Clause 85. The method of any of the preceding or successive clauses, wherein the stranded mesh material member forms a product; and wherein the method further comprises installing the product on a seat frame as a seat cushion.

Clause 86. A seat assembly formed using the method of any of the preceding or successive clauses.

Clause 87. A product manufactured according to the method of any of the preceding or successive clauses.

Clause 88. A system in combination with, or without, any one or more of the successive clauses, comprising: a dispenser to dispense a plurality of polymeric filaments; a funnel assembly comprising: a funnel comprising one or more side walls extending from an entrance to an outlet, the entrance positioned to receive polymeric filaments extruded from the dispenser; and wherein the funnel assembly further comprises at least one of: a liner comprising one or more elastic panels with the liner extending over an inner surface of the one or more side walls, or one or more movable sections forming at least one side wall of the one or more side walls and cooperating to define an opening for the funnel, wherein one of the entrance and the outlet define the opening.

Clause 89. The system of any of the preceding or successive clauses further comprising one or more actuators cooperating with the one or more movable sections, such that the one or more actuators, when actuated, move the one or more movable sections from a first position to a second position such that the opening changes from a first shape to a second shape.

Clause 90. The system of any of the preceding or successive clauses wherein the one or more actuators comprise a linear actuator.

Clause 91. The system of any of the preceding or successive clauses wherein the one or more actuators cooperate with a shaft such that when the shaft rotates the one or more actuators move from a first position to a second position.

Clause 92. The system of any of the preceding or successive clauses further comprising a lubrication system in cooperation with the one or more movable sections.

Clause 93. The system of any of the preceding or successive clauses wherein the lubrication system comprises one or more lubricating spigots, wherein each movable section cooperates with a respective one of the lubricating spigots.

Clause 94. The system of any of the preceding or successive clauses wherein the dispenser comprises a die.

Clause 95. The system of any of the preceding or successive clauses wherein the dispenser comprises comprising a plurality of nozzles.

Clause 96. The system of any of the preceding or successive clauses further comprising a fluid bath, wherein the outlet of the funnel is submerged within the fluid bath, and the entrance is positioned above the fluid in the fluid bath; and at least one hose to direct fluid from the fluid bath onto the liner.

Clause 97. The system of any of the preceding or successive clauses further comprising a cooling bath to receive the plurality of polymeric filaments from the funnel.

Clause 98. The system of any of the preceding or successive clauses further comprising a conveyor assembly cooperating with the cooling bath to move the plurality of polymeric filaments.

Clause 99. Any one of the preceding clauses 1-98 in any combination.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

As used herein, an entity performing a task, optionally, is construed to mean the entity being configured to perform the respective task depending on the context.

1. An assembly comprising:
a funnel comprising one or more side walls extending from an entrance to an outlet;
wherein the assembly further comprises:
a liner comprising one or more elastic panels, the liner extending over an inner surface of the one or more side walls, wherein the liner comprises an inner edge defining an aperture therethrough, and extends outwardly from the inner edge to an outer edge; and/or
one or more actuators cooperating with the one or more side walls, wherein at least one side wall of the one or more side walls comprise a plurality of movable sections cooperating to define an opening for the funnel, and wherein one of the entrance and the outlet define the opening, such that the one or more actuators, when actuated, move the plurality of movable sections from a first position to a second position such that the opening changes from a first shape to a second shape, and a controller programmed to actuate the one or more actuators from a first predetermined shape to a second predetermined shape.

2. The assembly of claim 1 further comprising the liner and the one or more actuators.

3-20. (canceled)

21. An assembly comprising:
a funnel comprising one or more side walls extending from an entrance to an outlet;
wherein the assembly further comprises:
a liner comprising one or more elastic panels, the liner extending over an inner surface of the one or more side walls, wherein the liner comprises an inner edge defining an aperture therethrough, and extends outwardly from the inner edge to an outer edge; and/or
one or more actuators cooperating with the one or more side walls, wherein at least one side wall of the one or more side walls comprise a plurality of movable sections cooperating to define an opening for the funnel, and wherein one of the entrance and the outlet define the opening, such that the one or more actuators, when actuated, move the plurality of movable sections from a first position to a second position such that the opening changes from a first shape to a second shape;
wherein the assembly further comprises a controller programmed to actuate the one or more actuators from a first predetermined shape to a second predetermined shape; and
wherein the controller is programmed to actuate from a first predetermined shape to a second predetermined shape based on a line speed.

22-39. (canceled)

40. The assembly of claim 1 wherein the one or more side walls of the funnel define at least one concave surface and at least one convex surface.

41. The assembly of claim 1, wherein the liner cooperates with the movable sections to define the first and second shapes.

42. The assembly of claim 1, wherein the plurality of movable sections is disposed along a first side of the opening.

43. The assembly of claim 1, wherein the plurality of movable sections is disposed along one or more sides of the opening.

44. The assembly of claim 1, wherein the plurality of movable sections is disposed along each side of the opening.

45. The assembly of claim 1, wherein each actuator of the plurality of actuators is independently actuated.

46. The assembly of claim 1, wherein each actuator comprises a linear actuator.

47. The assembly of claim 1, wherein each actuator is connected to a respective one of the movable sections.

48. The assembly of claim 1, wherein an actuator of the one or more actuators is connected to a group of the movable sections.

49. The assembly of claim 1, wherein the one or more actuators cooperate with a shaft such that when the shaft rotates the one or more actuators move from a first position to a second position.

50. The assembly of claim 49, wherein the first shape comprises a straight, concave, or convex edge formed by the plurality of movable sections and the second shape comprises a different concave or convex edge formed by the plurality of movable sections.

51. The assembly of claim 1, wherein each movable section comprises a shaping portion and a connector that cooperates with the one or more actuators and shaping portion such that the one or more actuators moves the associated one or more shaping portions when actuated.

52. The assembly of claim 1, wherein the plurality of movable sections cooperates with a guide to direct movement of the plurality of movable sections when the actuator is actuated.

53. The assembly of claim 52 wherein the guide is a track such that each movable section translates along the track when actuated.

54-55. (canceled)

56. The assembly of claim 1, wherein the controller is programmed to meter lubricant to the funnel based on a line speed.

57-60. (canceled)

61. An assembly comprising:
a funnel comprising one or more side walls extending from an entrance to an outlet;
wherein the assembly further comprises:
a liner comprising one or more elastic panels, the liner extending over an inner surface of the one or more side walls, wherein the liner comprises an inner edge defining an aperture therethrough, and extends outwardly from the inner edge to an outer edge; and/or
one or more actuators cooperating with the one or more side walls, wherein at least one side wall of the one or more side walls comprise a plurality of movable sections cooperating to define an opening for the funnel, and wherein one of the entrance and the outlet define the opening, such that the one or more actuators, when actuated, move the plurality of movable sections from a first position to a second position such that the opening changes from a first shape to a second shape;
wherein each actuator of the one or more actuators is connected to a respective one of the movable sections, or the one or more actuators cooperate with a shaft such that when the shaft rotates the one or more actuators move from a first position to a second position; and/or wherein each movable section cooperates with a respective lubricating spigot of a lubricating system.

62-65. (canceled)

66. A system comprising:
a dispenser of a plurality of filaments of molten polymeric material; and
the assembly of claim 1, oriented relative to the dispenser to receive and shape the plurality of filaments.

67-98. (canceled)
